(19) United States
(12) Patent Application Publication
(10) Pub. No.: US 2026/0205669 A1
(43) Pub. Date: Jul. 16, 2026

(54) REINFORCEMENT LEARNING FRAMEWORK FOR ONLINE SYSTEMS

(71) Applicant: Microsoft Technology Licensing, LLC, Redmond, WA (US)

(72) Inventors: Shenyinying Tu, Sunnyvale, CA (US); Lijun Peng, Mountainview, CA (US); Yi Zhang, Los Altos, CA (US); Yuan Gao, Santa Clara, CA (US)

(73) Assignee: Microsoft Technology Licensing, LLC, Redmond, WA (US)

(21) Appl. No.: 19/020,285

(22) Filed: Jan. 14, 2025

(51) Int. Cl. H04N 21/80; G06N 3/092; H04N 21/431

(52) U.S. Cl. CPC H04N 21/80; G06N 3/092; H04N 21/431

(57) ABSTRACT

Artificial intelligence techniques for connection networking are described. A method comprises receiving a request for a set of content items for a content feed, generating a set of metrics for a first set of content items of a first type and a second set of candidate content items of a second type using a machine learning model, selecting a first content item of the first type from the first set of content items and a second content item of the second type from the second set of content items based on the set of metrics using a blending algorithm to form a blended set of content items, allocating the first content item and the second content item from the blended set of content items to multiple slots in the content feed, and presenting the blended set of content items within the content feed on a GUI of a device.

### BACKGROUND

Software applications harness the power of computer networks to distribute a wide variety of digital content to user computing devices. To assess the effectiveness of these content distribution systems, developers rely on “signals” generated at the recipient devices. These signals comprise measurable user interactions, including clicks, conversions, session durations, and a range of other user interface events. By analyzing these interactions, the reach and impact of a particular content delivery mechanism or ranking algorithm can be determined. The signals reveal whether the right audience is being targeted and engaged, and to what extent they respond to the distributed content. This feedback loop not only helps quantify performance but also guides the iterative refinement of ranking models, content personalization strategies, and overall user experience. Over time, the insights gleaned from these signals become invaluable for optimizing content distribution campaigns, ensuring that they are more closely aligned with evolving user preferences and behaviors.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a system in accordance with one embodiment.

FIG. 3 illustrates a content delivery system in accordance with one embodiment.

FIG. 4 illustrates a graphical user interface (GUI) view in accordance with one embodiment.

FIG. 5 illustrates a logic diagram in accordance with one embodiment.

FIG. 6 illustrates a logic diagram in accordance with one embodiment.

FIG. 7A illustrates a logic diagram in accordance with one embodiment.

FIG. 7B illustrates a machine learning (ML) architecture in accordance with one embodiment.

FIG. 8 illustrates an ML architecture in accordance with one embodiment.

FIG. 9 illustrates an ML architecture in accordance with one embodiment.

FIG. 10 illustrates a training algorithm in accordance with one embodiment.

FIG. 11 illustrates a logic flow in accordance with one embodiment.

FIG. 12 illustrates a logic flow in accordance with one embodiment.

FIG. 13 illustrates an apparatus in accordance with one embodiment.

FIG. 14 illustrates a logic diagram in accordance with one embodiment.

FIG. 15 illustrates an artificial neural network (ANN) in accordance with one embodiment.

FIG. 16 illustrates a computer-readable storage medium in accordance with one embodiment.

FIG. 17 illustrates a computing architecture in accordance with one embodiment.

FIG. 18 illustrates a communications architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. Some embodiments, for example, provide a technical solution to a technical problem of blending different types of content items (e.g., organic content and sponsored content) in a content feed of a graphical entity interface (GUI) of a connection network system. The content items are displayed within ordered sets of user interface “content slots” (or slots) which can assume various configurations. A common example is a GUI content feed, such as a news feed or professional media timeline, where content slots are arranged sequentially and scrolled either horizontally or vertically. However, many other spatial arrangements fit this concept, including grids, horizontally aligned notifications, and vertical pop-ups. In each case, content items occupy specific slots that are updated in real time based on the adaptive ranking system. Specific slots may be in a rendered area of the GUI for presentation to a user on an electronic display, while other slots may be in a non-rendered area (or pre-rendered) of the GUI that is ready for presentation to a user. This approach ensures users receive relevant information dynamically while scrolling, with the flexibility to adjust slot allocation and ordering according to evolving usage patterns and contextual factors.

Specifically, embodiments blend and display different types of data in a way that optimizes for a given objective, such as a revenue objective (e.g., short term revenue, long term revenue, lifecycle revenue, etc.). A ML technique such as reinforcement learning is used to learn an action to take in different situations by testing different configurations and measuring results. A reinforcement learning model learns from historical data, such as what types of content were shown to an entity, when they were shown to the entity, and how different entities (e.g., users) respond to the content. This learning approach helps the reinforcement learning model to make smarter decisions about when and where to show a particular type of content in the content feed. This solution keeps entities engaged while optimizing for a given objective. Although exemplary embodiments are described in connection with a particular AI system or an ML model, the principles described herein can also be applied to other types of AI systems and ML models as well. Embodiments are not limited in this context.

### Overview

A connection network system may provide access to a large amount of electronic content aimed at professional networking and career development. For example, a connection network system may list employment opportunities posted by employers across different industries, professional profiles with detailed information about entities of the connection network system (e.g., work experience, skills, and endorsements), articles or posts created by entities and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where entities can share ideas and discuss industry trends, and other types of content designed to facilitate professional growth and industry engagement.

Various types of entities may generate, modify, store, read, or otherwise interact with the electronic content of the connection network system. Non-limiting examples of an entities include an individual, a person, an entity, a member, a subscriber, a corporate entity, a company, a business, an organization, a governmental agency, a community, a group, and the like. In some cases, the connection network system collects a variety of data associated with the various types of entities of the platform in accordance with privacy policies which govern how this information is collected, used, and shared. For an entity such as an entity, the entity data may include basic profile information such as name, job title, industry, location, educational background, demographic information, work history, and so forth. For an entity such as a company, the entity data may also include basic profile information such as a company name, description, industry, business segment, jobs, careers, offices, geographic locations, and so forth. Additionally, the connection network system may collect activity data for entities representing various interactions and behaviors exhibited while on the platform. Examples of activity data including interactions between entities or interacting with electronic content of the connection network system, including profile updates, content engagement, search and navigation behavior, job activities, networking activities, group participation, skill endorsements and recommendations, advertisement engagement, learning activities, event participation, followers activities, interactions with external content, engagement patterns, behavioral trends, organic content, sponsored content, sales activities, marketing activities, and so forth.

In some cases, a connection network system may enhance network services offered by the connection network system based on the entity data and activity data of its entities. Examples of network services include messaging services, search services, ranking services, recommendation services, advertising services, content delivery services, and so forth. For example, a connection network system may use activity data to personalize entity experiences, optimize content displayed in feeds, improve targeted advertising, and enhance platform features. It also plays a role in developing analytics and reporting tools, helping entities and businesses understand their network reach, content effectiveness, and engagement with their audience.

A connection network system may offer a content delivery system that delivers electronic content items to various entities based on a number of different factors. For example, the content delivery system may interleave different types of content items for presentation in a content feed on an electronic device for viewing by an entity. The content feed is a prominent content area on a webpage (e.g., a homepage) of a website where an entity may view a personalized stream of posts, updates, articles, and activities. It compiles content from network connections, companies followed, and topics of interest to keep informed about professional news, industry trends, job opportunities, and other relevant information for career development. An entity may interact with the content items presented in the content feed by liking, commenting on, and sharing posts, as well as following hashtags to tailor the content to specific interests. The content feed serves as a central hub for networking, learning, and staying updated within a professional community, all personalized through algorithms based on connections and engagement history.

The content feed may comprise a portion of a web section that displays a mixture of different types of content items, such as organic items generally referred to as organic content (OC) and sponsored items generally referred to as sponsored content (SC), for example. OC refers to digital content items that entities share with each other in a connection network system without payment. Non-limiting examples of OC include articles, shares, likes, and so forth. SC refers to digital content items that entities share in a connection network system with payment. Non-limiting examples of SC include digital advertisements, marketing collateral, and so forth. A digital content item may comprise multimedia information of different modalities, such as text, video, graphics, images, audio, animations, or any combination of the foregoing.

A content delivery system uses a blending algorithm that assigns, allocates, interleaves, or loads OC and SC to content slots in the content feed. A content slot (or simply a slot) is a section of the content feed of some defined dimension and geometry designed to display a given content item to the entity. The section may be rendered to an entity or non-rendered (pre-rendered) to the entity depending on a position of the content feed relative to the GUI. The content delivery system may select the different types of content items for different slots of the content feed based on a combination of the entity data, activity data, and/or objectives associated with the entity in order to personalize the content feed. For example, the blending algorithm may select an OC for a first slot of the content feed to increase an engagement metric for the entity, such as a number of likes, comments, or shares. The blending algorithm may select a SC for a second slot of the content feed to increase a revenue metric for the entity. As the entity scrolls through the content feed the blending algorithm assigns more content items to more slots in a seamless and continuous manner. During this process, the blending algorithm attempts to blend the OC and SC in the content feed to achieve one or more defined objectives. The result of this process is a content feed that interleaves the OC and SC in a continuous manner.

Determining whether to select a given content item for the content feed to optimize a multi-objective goal, however, remains a difficult and complex technical problem. For example, a naive approach is to simply assign the OC and SC to fixed slots in the content feed, such as every second slot or ninth slot out of 12 slots. This approach is simple and fast to implement. However, using fixed slots means that the blending algorithm is incapable of performing dynamic adjustments. Another solution is deterministic or near-deterministic slotting where the OC or SC is concentrated around a few slots based on some algorithm. However, entities may become de-sensitized to certain OC or SC when recurring in the same or similar slots for every session. Other solutions may attempt to randomly select slots or offsets for slots. These randomized solutions are incapable of meeting objectives, and they may actually decrease engagement or reduce entity experience, particularly when a long series of OC or SC are presented due to randomness. None of these solutions are capable of efficiently and effectively presenting a mixture of different types of content on a content feed that optimize for one or more objectives.

Embodiments solve these and other technical challenges. Embodiments are generally directed to AI and ML techniques to support various network services for an online connection network system. Some embodiments are particularly directed to a novel AI architecture and framework that implements various ML models trained and deployed to perform inferencing operations in support of a network service. Non-limiting examples of network services include feed services, search services, ranking services, recommendation services, advertising services, content delivery services, and other types of network services. In some embodiments, the AI and ML techniques are used to improve feed services as discussed herein. However, embodiments are not limited to feed services, and can be applied to other network services as well. Embodiments are not limited in this context.

Some embodiments, for example, provide a technical solution to the feed placement technical problem of blending different types of data (e.g., OC and SC) in a content feed of a connection network system to optimize for a set of one or more objectives, such as an engagement objective (e.g., clicks, impressions, likes, etc.), a short term revenue objective, a long term revenue objective, a lifecycle revenue objective, a touchpoint objective, a recommendation objective, a ranking objective, and so forth. A content delivery system may implement a novel blending algorithm to blend different types of content items in the content feed. The blending algorithm may use AI and ML techniques such as reinforcement learning to learn an action to take in different situations by testing different configurations of the content feed and measuring results. In particular, a reinforcement learning model learns from historical data, such as what types of content were shown to an entity, when they were shown to the entity, and how different entities (e.g., users) responded to the content. This learning approach helps the reinforcement learning model to make smarter decisions about when to show a particular type of content (e.g., OC or SC) in the content feed. In some embodiments, the reinforcement learning model can be trained to perform inferencing operations for a specific entity. In this case, the model tracks data over a longer observation window (e.g., longer time period), and is therefore able to predict a longer term value for the entity using a model tailored on specific entity activity data (e.g., interactions with content items) and/or entity data (e.g., entity attributes, entity profile data, etc.). This solution keeps entities engaged while optimizing for the given set of objectives.

More particularly, a connection network system utilizes a content delivery system to gain revenue via the content feed. The content feed displays different content items associated with different fee structures. For example, when an entity consumes an OC there is one fee, and when the entity consumes an SC there is another fee. Displaying more SC is beneficial to SC revenue but harmful to OC revenue since SC is less likely engaging than OC. Therefore, a number of SC is limited in the content feed to ensure a good user experience and engagement. Hence, how to allocate limited slots reasonably and effectively to maximize overall revenue has become a very meaningful and challenging problem.

In some embodiments, the content delivery system implements a feed mixer (or blending server) utilizing a blending algorithm to allocate content items to the content feed. The feed mixer takes an SC sequence and an OC sequence as input and it outputs a mixed sequence of the two. The blending algorithm implements a dynamic slots strategy that adjusts a number and slots of SC according to the interest of entities. For instance, if a user has a higher tendency to consume SC, the blending algorithm will allocate more SC at conspicuous slots to maximize possible benefits. Since the content feed is presented to the entity in a sequence, the feed mixer implements the dynamic slots strategy by modeling the problem as a Markov Decision Process (MDP) as discussed in detail herein, and solve it using reinforcement learning (RL).

Once the feed mixer outputs a mixed sequence it is displayed for the entity on a device. As the entity interacts with the content feed (e.g., views, clicks, impressions, implicit feedback, explicit feedback, etc.), feedback information is generated for the feed mixer. For example, once an SC is inserted into the content feed, a click-through rate (CTR) of surrounding OC and SC fluctuates. For example, inserting an SC into the content feed causes the CTR of organic items to increase while the CTR of sponsored items decreases. The fluctuating CTR is an arrangement signal which represents the influence of the arrangement of displayed items on user behaviors. The feed mixer uses the arrangement signal as a basis for a better allocation strategy. As a result, the feed mixer achieves an efficient balance between the personalization of different requests and the constraint on the percentage of advertisements (PAE) in a period. PAE is a notable constraint in SC allocation, which balances the user experience and platform revenue.

The feed mixer implements an ML model to explicitly extract the arrangement signal. In some embodiments, the ML model is a Deep Q Network (DQN). A DQN uses a reinforcement learning algorithm that combines Q-learning with deep neural networks (DNN). A DQN uses neural networks to approximate a Q-value function, which predicts the expected future rewards of taking a certain action in a given state. By storing and randomly sampling past experiences, DQNs get more efficient use of previous experience, by learning with it multiple times

In some embodiments, for example, the feed mixer implements a cross DQN. A cross DQN is a convolutional neural network (CNN) designed to map states and actions into values. The model takes a state (e.g., OC sequences, SC sequences, context information, etc.) and the corresponding candidate actions as the input. Then, an item representation module (IRM) generates the representations, particularly the representations of SC and OC. Next, a sequential decision module (SDM) generates Q-values of different actions with the assistance of a state and action crossing unit (SACU), a multi-channel attention unit (MCAU), and an auxiliary loss for batch-level constraint. In the SACU, the state embeddings are intersected according to the action to form a unified matrix representation. In the MCAU, the crossing matrix generated from the SACU is split into different channels to calculate a multi-channel attention weight. Finally, the SDM selects the action with the largest Q-value. The feed mixer uses the selected action to allocate an OC or SC in a given slot of the content feed.

In various embodiments, the DQN or cross DQN are designed to generate predictions over a longer observation window (e.g., longer period of time) relative to conventional ML models that use a shorter observation window. Conventional ML models typically use partial state information at each timestep, such as a single snapshot (e.g., a single event). However, to infer velocity, interactions or other time-dependent cues, the ML model may need to see multiple recent events. A longer observation window stacks multiple events that helps the network learn transitions that a single event alone cannot reveal. For example, if certain clues about future rewards happen over longer time spans (e.g., such as in an advertising campaign with multiple digital advertisements and member interactions thereof), a larger observation window helps the model retain that context without requiring more complex architectures, such as recurrent neural networks (RNN) or long short-term memory (LSTM) models. For shorter observation windows, the model will output values with decreased accuracy by limiting the view to only a limited number of events. While shorter windows may capture immediate dynamics (e.g., isolated events such as a single member interaction with a single digital advertisement), longer windows provide more precise predictions for slowly changing or delayed cues that affect reward. Consequently, the DQN or cross DQN are trained on longer observation windows capturing more events to provide a longer term Q-value for more precise predictions relative to shorter term Q-values generated on limited datasets.

While effective, the DQN model consumes a significant amount of resources to train and it also introduces latency when performing inferencing operations. In some cases, these constraints are not suitable for an online system. The content delivery system of the connection network system may service millions of entities around the world simultaneously, constantly updating content feeds for the entities with new OC and SC in different geographic locations. As such, implementing a DQN model for a large-scale industrial online system can be challenging.

To address this technical problem, the content delivery system implements two different execution pipelines, such as an online execution system and an offline execution system. The online execution system performs feed services in real-time or near real-time. For example, when an entity starts a session with the connection network system, the content delivery system begins serving OC and SC in the content feed for the session using the online execution system. The offline execution system performs background tasks to support the online execution system. For example, the offline execution system may train ML models, update databases and indices, retrieve and store data, and other tasks. In some cases, these tasks can take hours, days, or even weeks to accomplish.

In some embodiments, the online execution system performs inferencing operations for the feed mixer using a trained ML model such as the DQN model or cross DQN model. The offline execution system performs training operations for the ML model, and it then writes the ML model to the online execution system for inferencing operations. The ML model may be trained or retrained on a regular basis, such as daily, weekly, or monthly, depending on model training time and available training data. Even while bifurcating these functions, however, the DQN model may still be too large to perform inferencing operations within latency constraints for the online execution system. Therefore, some embodiments use several techniques to solve this technical problem, such as reducing dimensions for the model using embeddings, using defined thresholds during online serving, and using backup models in case the primary model fails.

In particular, some embodiments decompose the DQN model into different parts, such as the IRM and SDM for deployment. The two parts are trained offline end-to-end. However, they are deployed separately for the online execution system to reduce the latency. The IRM can be computed in parallel with ranking models for the OC and SC. Therefore, the only additional latency introduced into the online execution system is the SDM inferencing operation, which is relatively small and normally within the latency constraints of the online execution system.

The embodiments disclosed herein provide several technical solutions to technical problems faced by conventional systems. For example, conventional solutions assume all requests are independent and identically distributed (i.i.d) and therefore do not discriminate between a request and an entity. Each request is considered as a new entity that has been sampled i.i.d. from the population of entities. This results in difficulties in evaluating returning requests and entities. In another example, conventional algorithms attempt to optimize for a single objective, such as short-term revenue. These algorithms are myopic and do not optimize for long-term effect. An overemphasis on short-term may hurt long-term revenue, and vice-versa. For instance, showing too many SC can boost short-term revenue at the cost of long-term revenue thereby leading to long-term revenue drop. Embodiments formulate the content blending problem as a dynamic programming problem, and solve it in a reinforcement learning manner. In some embodiments, the feed mixer uses the arrangement signal to model the influence of arrangement of content items thereby leading to a better allocation strategy. Conventional solutions ignore the arrangement signal, and simply allocate SC to pre-determined slots. The feed mixer utilizes a ML model to extract the arrangement signal to support dynamic slots allocation to OC and SC. This leads to lower ad blindness and better adaptability, significantly outperforming convention systems using fixed slots strategies. The feed mixer models the blending problem as a Markov decision process and solves it using reinforcement learning. The feed mixer bifurcates inferencing and training operations for ML models into separate execution environments. Further, the feed mixer decomposes the ML models into constituent parts to accelerate inferencing operations and reduce latency when serving OC and SC in content feeds. Most conventional solutions lack an efficient balance between personalization of different requests and constraints on PAE in a period. PAE is an important constraint in content allocation, which balances user experience and platform revenue. Previous methods constrain all the requests or the requests within the same time period (e.g., an hour) with the same target PAE, resulting in a lack of personalization and differentiation in the allocation of SC between different requests. The feed mixer addresses this limitation using a DQN model based on deep reinforcement learning to balance the personalization of different requests and the constraint on PAE in a period. Embodiments provide other technical solutions to other technical problems as well.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Detailed Embodiments

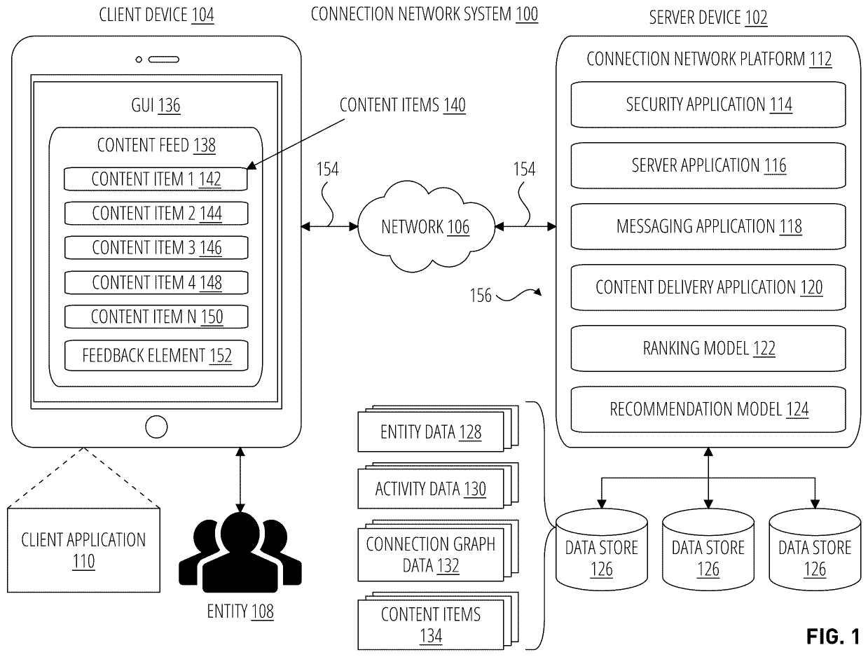

FIG. 1 illustrates a connection network system 100. The connection network system 100 is an example of an architecture or framework for an online computer and communications system designed to serve content items to an electronic device associated with an entity. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, entity-interface module, entity-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. In operation, an entity 108 interacts with a client application 110 of the client device 104 to access applications and services provided by a connection network platform 112 of the server device 102. The connection network platform 112 offers a number of network services 156 for the connection network system 100, such as network services provided by a security application 114, a server application 116, a messaging application 118, a content delivery application 120, a ranking model 122, and/or a recommendation model 124. The server device 102 has access to one or more data stores 126. The data stores 126 store information for the connection network platform 112, such as entity data 128, activity data 130, connection graph data 132, and content items 134.

The connection network system 100 comprises a server device 102. In particular embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network entity 108 at a client device 104 via the network 106. A client device 104 may enable its entity 108 to communicate with other entities 108 at the server device 102, such as via messaging applications 118.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about an entity's actions on or off the connection network platform 112. In conjunction with the action log, a third-party-content-object log may be maintained of entity exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the entities of the connections networking system. A privacy setting of an entity determines how particular information associated with an entity can be shared. The authorization server may allow entities to opt in to or opt out of having their actions logged by the connection network platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with entities. Advertisement-pricing modules may combine connections information, the current time, location information, or other suitable information to provide relevant advertisements, in the form of notifications, to an entity.

The connection network system 100 comprises a connection network platform 112. In particular embodiments, the connection network platform 112 may be part of a network-addressable computing system that can host an online connection network. The connection network platform 112 may generate, store, receive, and send connection networking data, such as, for example, entity data 128 (e.g., entity-profile data, concept-profile data, etc.), activity data 130 (e.g., entity interactions with connection network platform 112), connection graph data 132 (e.g., connections between entities or entities), content items 134, or other suitable data related to the online connection network. The connection network platform 112 may be accessed by the other components of the connection network system 100 either directly or via a network 106. As an example and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 comprises a security application 114. In particular embodiments, a security application 114 may be an application or electronic device including hardware, software, or embedded logic components or a combination of two or more such components and capable of carrying out the appropriate functionalities implemented or supported by the security application 114. The security application 114 is a network security system that encompasses a suite of technologies, policies, and practices designed to protect the integrity, confidentiality, and availability of data within the connection network platform 112 from unauthorized access, attacks, and other security threats. The security application 114 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized entities can access and understand it. Effective network security also requires rigorous access control to restrict network resources to authorized entities, alongside Security Information and Event Management (SIEM) systems for real-time security alert analysis. Endpoint security further safeguards devices connected to the network, which are frequent entry points for security threats. The security application 114 implements security practices to ensure a robust defense against a wide array of cyber threats, safeguarding organizational assets and maintaining trust with stakeholders.

The connection network platform 112 comprises a server application 116. In particular embodiments, the server application 116 may be a web server to serve content information, such as content items 134, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the entity 108.

In particular embodiments, the server application 116 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 116 may be an e-commerce application, a content application, an advertisement application, a web interface, a messaging application, a video application, a webpage, and so forth.

In particular embodiments, the server application 116 may be an application for managing various applications and services provided by the online connection network hosted on the connection network platform 112. In particular embodiments, the server application 116 may include hardware, software, or embedded logic components or a combination of two or more such components for carrying out the appropriate functionalities implemented or supported by connection network platform 112. Although the server device 102 is shown with a single server application 116, it should be noted that this is not by any way limiting and this disclosure contemplates any number of server applications 116.

The connection network platform 112 comprises a messaging application 118. The messaging application 118 is software that enables entities to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage entity identities, contacts, and groups, while ensuring security through authentication and encryption measures. Designed to operate over various network types, such as Wi-Fi or cellular data, messaging applications can also integrate with other network services and platforms, enhancing their functionality and entity experience.

The connection network platform 112 comprises a content delivery application 120. The content delivery application 120 is a software tool that allows entities to efficiently deliver content items to other entities of the connection network platform 112 of the connection network system 100, such as content items 134 stored by one or more data stores 126 or third-party content servers. An example for the content delivery application 120 is a demand-side platform (DSP) used by entities such as employees (e.g., an account manager) for an advertising entity. A DSP allows advertisers to purchase and manage ad inventory from multiple ad exchanges and networks through a single interface to implement marketing solutions for products or services of the advertiser. The content delivery application 120 allows advertisers to create, manage, and analyze their ad campaigns on the platform in accordance with a larger programmatic advertising strategy. It allows for precise targeting based on entity data 128 and/or activity data 130, making it especially useful for business-to-business (B2B) or business-to-consumer (B2C) marketing campaigns. The content delivery application 120 delivers content items 134, such as a series of one or more advertisements, to an audience of entities 108 of the connection network platform 112 of the connection network system 100. The content delivery application 120 assist advertisers in delivering content and ads to a professional audience by leveraging entity profiles, job titles, industries, and other entity data 128 and activity data 130 collected by the connection network platform 112.

The connection network platform 112 comprises various machine learning (ML) models, such as a ranking model 122. A ranking model 122 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to entities.

The connection network platform 112 comprises various ML models, such as a recommendation model 124. A recommendation model 124 in machine learning is an ML model designed to predict and suggest items that are likely to be of interest to entities, analyzing patterns in entity behavior, preferences, and interactions to generate personalized recommendations. These models are widely used in e-commerce, streaming services, and social media to enhance entity experience and engagement. Techniques include collaborative filtering, which identifies similarities between entities and items based on interactions and feedback, and content-based filtering, which recommends items similar to those an entity has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 102 comprises, or has access to, one or more data stores 126. In particular embodiments, the connections networking system 102 may include a data store 126. The data store 126 may be used to store various types of information for the server device 102 and/or the connection network platform 112. In particular embodiments, the information stored in the data store 126 may be organized according to specific data structures. In particular embodiments, the data store 126 may be a relational, columnar, correlation, or other suitable database. Although this disclosure describes or illustrates particular types of databases, this disclosure contemplates any suitable types of databases. Particular embodiments may provide interfaces that enable a client device 104 or a connection network system 100 to manage, retrieve, modify, add, or delete, the information stored in the data store 126.

In one embodiment, for example, the data store 126 stores entity data 128 for the connection network platform 112. In particular embodiments, the connection network platform 112 may include entity data 128 for various entities of the connection network platform 112. Non-limiting examples of entities may include entities, individuals, members, businesses, companies, organizations, software agents, hardware agents, and so forth. For example, the entity data 128 may comprise one or more entity profiles associated with entities of the connection network platform 112. An entity profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate entities who have similar or common work experience, group memberships, hobbies, educational history, or are in any way related or share common attributes. The connection information may also include entity-defined connections between different entities and content (both internal and external).

In one embodiment, for example, the data store 126 stores activity data 130 for the connection network platform 112. The activity data 130 represents various activities recorded for an entity 108 by the connection network platform 112. In particular embodiments, the connection network platform 112 may provide entities (e.g., entities) with the ability to take actions on various types of items or objects supported (or accessible) by connection network platform 112. As an example and not by way of limitation, the items and objects may include groups or connections networks to which entities of the connection network platform 112 may belong, events or calendar entries in which an entity might be interested, computer-based applications that an entity may use, transactions that allow entities to apply to job openings or post job openings via the service, interactions with advertisements that an entity may perform, content items, online games, or other suitable items or objects. An entity may interact with anything that is capable of being represented in the connection network platform 112 or by an external system of a third-party system, which is separate from the server device 102 and coupled to the server device 102 via a network 106.

In one embodiment, for example, the data store 126 stores connection graph data 132 for the connection network platform 112. The connection network platform 112 may store connection graph data 132 for one or more entities (e.g., members with subscription accounts) of the connection network platform 112. In one embodiment, for example, connection graph data 132 may be connection data for entities organized as a graph. The graph may include multiple nodes, which may include multiple entity nodes each corresponding to a particular entity or multiple entity nodes each corresponding to a particular entity, such as a business entity. The graph may also have multiple edges connecting the nodes. The connection network platform 112 may provide entities of the online connection network system 100 the ability to communicate and interact with other entities. In particular embodiments, entities may join the online connection network platform 112 via the connection network system 100 and then add connections (e.g., relationships) to a number of other entities of the connection network platform 112 to whom they want to be connected. Herein, the term “connection” may refer to any other entity of the connection network platform 112 or the connection network system 100 with whom an entity has formed a friendship, association, or relationship via the connection network platform 112.

In one embodiment, for example, the data store 126 stores content items 134 for the connection network platform 112. The content items 134 may comprise any type of multimedia content, such as text files, multimedia files, image files, video files, graphic files, movies, articles, entity feeds, advertisements for a content delivery campaign, banners, recommendations, games, messages, emojis, program code, animations, and so forth. In particular embodiments, the connection network platform 112 also includes entity-generated content (UGC) objects, which may enhance an entity's interactions with the connection network platform 112. entity-generated content may include anything an entity can add, upload, send, message, or “post” to the connection network platform 112. As an example and not by way of limitation, an entity communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network entity at a client device 104 to access a network 106. A client device 104 may enable its entity 108 to communicate with other entities 108 at other client devices 104, such as via messaging application 118.

The connection network system 100 comprises a client application 110. In particular embodiments, a client device 104 may include a client application 110, which may be a web browser, and may have one or more add-ons, plug-ins, or other extensions. An entity 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the entity 108. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 118 for messaging with entities 108 of a messaging network or system, a web browser application, an internet searching application, and so forth.

In particular embodiments, the client application 110 may be storable in a memory and executable by a processor circuitry of the client device 104 to render entity interfaces, receive entity input, send data to and receive data from the connection network platform 112. The client application 110 may generate and present entity interfaces to an entity via an electronic display of the client device 104. For example, the client application 110 may generate and present a GUI 136 based at least in part on information received from the server device 102, the connection network platform 112, and/or another device or system (e.g., a third party server) via the network 106.

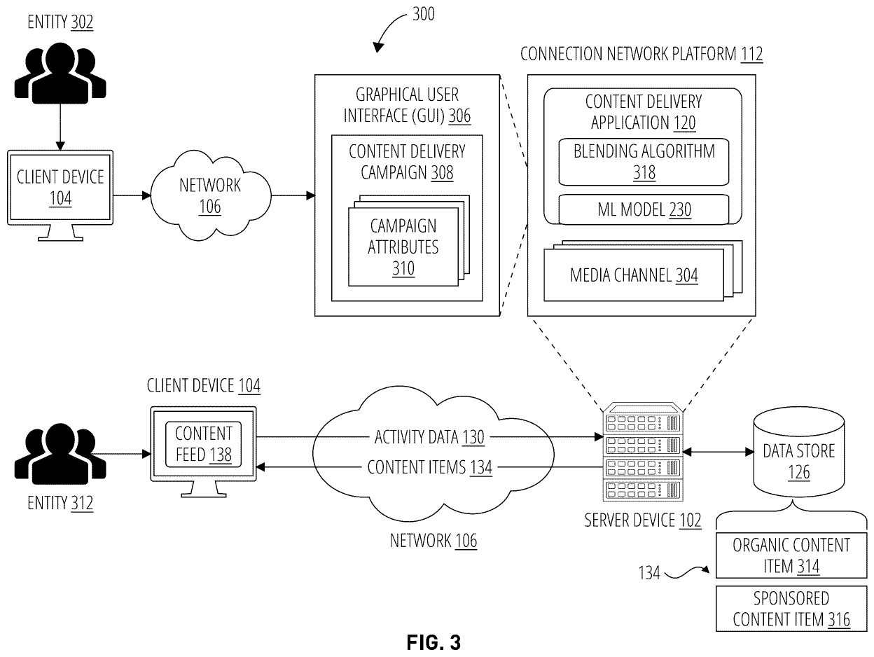

In some embodiments, the connection network platform 112 and/or the client application 110 and/or an operating system of the client device 104 may generate a GUI 136 on an electronic display of the client device 104. The client application 110 may receive one or more content items 134 from the data store 126 of the connection network platform 112 from the content delivery application 120. The client application 110 may display the content items 134 as content item 1 142 on a content feed 138 of the GUI 136. The content item 1 142 may include a feedback element 152 that when selected or activated by the entity 108, causes the GUI 136 to generate a signal such as a message for delivery to the content delivery application 120 of the connection network platform 112. The signal or message may comprise a feedback signal to the content delivery application 120 for use by the content delivery application 120 to select a new content item from the data store 126 for delivery to the client device 104. For example, the content delivery application 120 may use the feedback signal as part of an ML model to select content items 134 for a marketing campaign managed by the content delivery application 120, as described in more detail with reference to FIG. 3.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, an entity 108 interacts with a client application 110 of the client device 104 to access applications and services provided by a connection network platform 112 of the server device 102 via one or more links 154 of the network 106. The links 154 may connect each client device 104 to the connection network platform 112 via the network 106. This disclosure contemplates any suitable link 154. In particular embodiments, one or more links 154 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 154 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 154, or a combination of two or more such links 154. Links 154 need not necessarily operate at the same throughout. One or more first links 154 may differ in one or more respects from one or more second links 154.

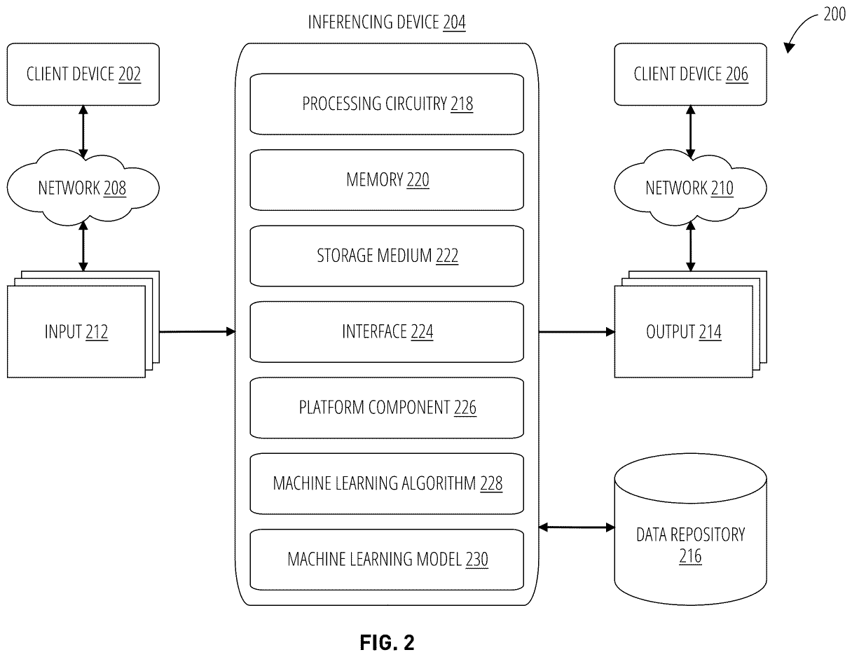

FIG. 2 illustrates an embodiment of a system 200. The system 200 is suitable for implementing one or more embodiments as described herein. In one embodiment, for example, the system 200 is an AI/ML system suitable for implementing models described with reference to any of the preceding description.

The system 200 comprises a set of M devices, where M is any positive integer. FIG. 2 depicts three devices (M=3), including a client device 202, an inferencing device 204, and a client device 206. The inferencing device 204 communicates information with the client device 202 and the client device 206 over a network 208 and a network 210, respectively. The information may include input 212 from the client device 202 and output 214 to the client device 206, or vice-versa. In one alternative, the input 212 and the output 214 are communicated between the same client device 202 or client device 206. In another alternative, the input 212 and the output 214 are stored in a data repository 216. In yet another alternative, the input 212 and the output 214 are communicated via a platform component 226 of the inferencing device 204, such as an input/output (I/O) device (e.g., a touchscreen, a microphone, a speaker, etc.).

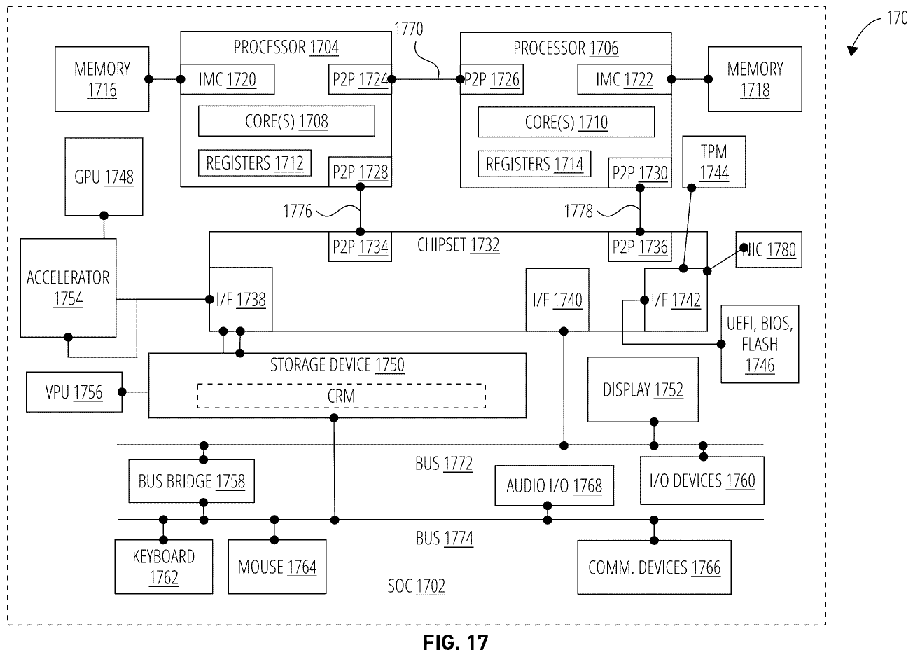

As depicted in FIG. 2, the inferencing device 204 includes processing circuitry 218, a memory 220, a storage medium 222, an interface 224, a platform component 226, ML algorithm 228, and an ML model 230. In some implementations, the inferencing device 204 includes other components or devices as well. Examples for software elements and hardware elements of the inferencing device 204 are described in more detail with reference to a computing architecture 1700 as depicted in FIG. 17. Embodiments are not limited to these examples.

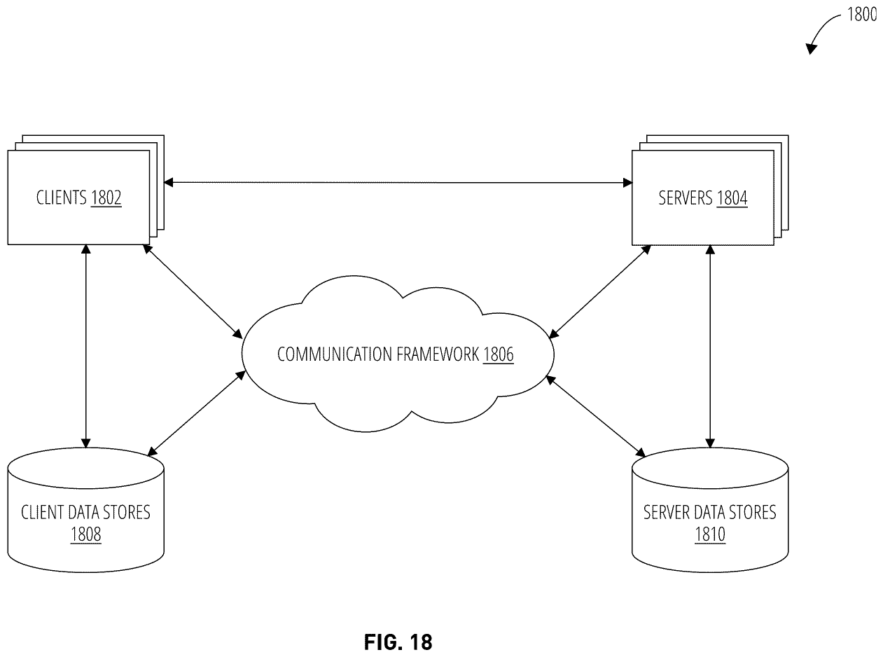

The inferencing device 204 is generally arranged to receive an input 212, process the input 212 via one or more AI/ML techniques, and send an output 214. The inferencing device 204 receives the input 212 from the client device 202 via the network 208, the client device 206 via the network 210, the platform component 226 (e.g., a touchscreen as a text command or microphone as a voice command), the memory 220, the storage medium 222 or the data repository 216. The inferencing device 204 sends the output 214 to the client device 202 via the network 208, the client device 206 via the network 210, the platform component 226 (e.g., a touchscreen to present text, graphic or video information or speaker to reproduce audio information), the memory 220, the storage medium 222 or the data repository 216. Examples for the software elements and hardware elements of the network 208 and the network 210 are described in more detail with reference to a communications architecture 1800 as depicted in FIG. 18. Embodiments are not limited to these examples.

The inferencing device 204 includes ML algorithm 228 and an ML model 230 to implement various AI/ML techniques for various AI/ML tasks. The ML algorithm 228 receives the input 212, and processes the input 212 using the ML model 230. The ML model 230 performs inferencing operations to generate an inference for a specific task from the input 212. In some cases, the inference is part of the output 214. The output 214 is used by the client device 202, the inferencing device 204, or the client device 206 to perform subsequent actions in response to the output 214.

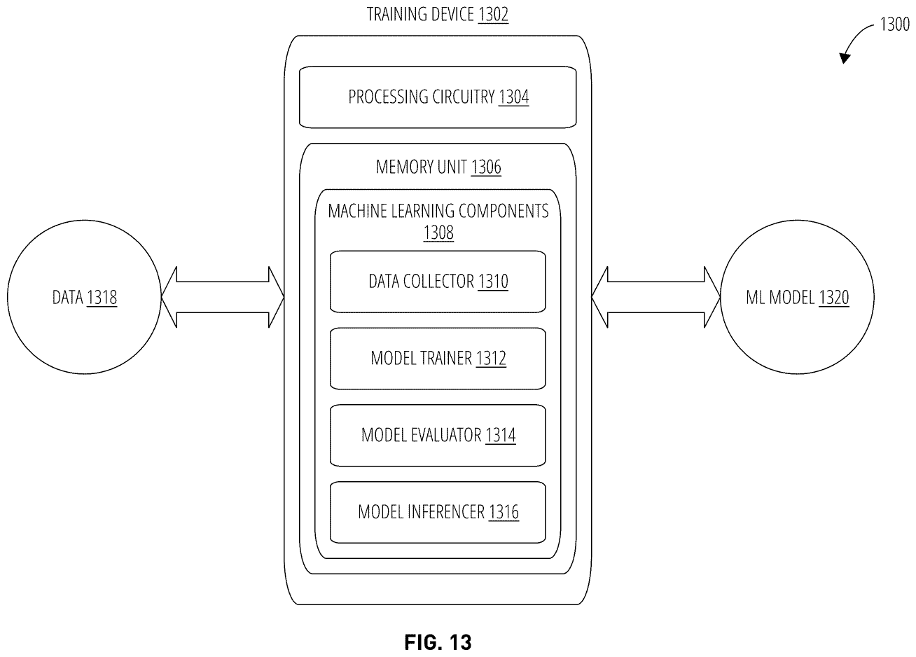

In various embodiments, the ML model 230 is a trained ML model 230 using a set of training operations. An example of training operations to train the ML model 230 is described with reference to FIG. 13.

FIG. 3 illustrates a content delivery system 300. The content delivery system 300 is an example of a system designed to deliver one or more content items 134 such as one or more organic content items 314 to an entity 312 of one or more entities 108 of the connection network platform 112 of the connection network system 100. The content delivery system 300 delivers the organic content items 314 in a targeted manner. The content items 134 may comprise, for example, recommendations, advertisements, content, messages, suggestions, hyperlinks, files, job postings, articles, and any other content offered by the connection network platform 112 of the connection network system 100.

In various embodiments, the connection network system 100 may use the content delivery system 300 to provide a content delivery service via a content delivery application 120 (e.g., software as a service (SaaS)) to its entities 108 (e.g., individuals, members, entities, groups, etc.). The content delivery system 300 is generally designed to deliver electronic content items 134 to entities 108 based, at least in part, on entity data 128 and activity data 130 of entities 108 of the connection network system 100. In particular, the content delivery system 300 may deliver content items 134 such as organic content items 314 specifically targeted to an audience of entities 108 based on entity data 128 or activity data 130. For instance, a content producer such as an advertiser may create a content delivery campaign such as a marketing campaign or advertising campaign to deliver a series of organic content items 314 for a product or service of a business entity to an audience of entities 108 of the connection network system 100 over a defined time interval (e.g., weeks, days, months, etc.). The content producer defines, controls, or manages the content delivery campaign 308 using a set of campaign attributes 310. The campaign attributes 310 may include various objectives of the content delivery campaign 308, such as increasing exposure, revenue, engagement, reach, and so forth.

The content delivery system 300 comprises a set of one or more client devices 104, server devices 102, and data stores 126. A client device 104 and a server device 102 may communicate information via a network 106. The client device 104 may comprise an electronic device, such as a smartwatch, smartphone, tablet, laptop computer, desktop computer, and so forth. The server device 102 may be implemented as a server in a data center, such as a cloud computing system or edge computing system. The client device 104 and the server device 102 may be implemented using an architecture as described in FIG. 17. The network 106 may be implemented using an architecture as described in FIG. 18. Embodiments are not limited to these example implementations.

The server device 102 implements a connection network platform 112 as described with reference to FIG. 1. In one embodiment, the connection network platform 112 includes at least one processor circuitry, at least one memory unit operably coupled to the processor circuitry, the memory unit including instructions executable by the at least one processor circuitry, and an ML model 230 comprising parameters and/or hyperparameters stored in the at least one memory unit. In one embodiment, for example, the ML model 230 is implemented as a multi-tower ML model for an AI system implemented by the content delivery system 300 to offer a network service such as a content delivery service by the content delivery application 120 of the connection network platform 112. The content delivery application 120 may select one or more content items 134, such as organic content items 314 and/or organic content items 314, for delivery as targeted content over one or more media channels 304 to a client device 104. A GUI 136 may present the content items 134 in a content feed 138 on the client device 104. An entity 108 from the entity 312 may interact with a GUI element of the GUI 136 to access the targeted content, such as scrolling through the content feed 138 in an X, Y or Z dimension to view the content items 134, clicking on an organic content item 314 or sponsored content item 316 for further inspection, providing feedback using a feedback element 152, and other activities.

The server device 102 may include connection network platform 112 implementing a network service to entity 108 of the connection network platform 112. Professional networking platforms offer a wide range of networking services to facilitate connections, career development, and knowledge sharing. Some examples of a network service offered by the connection network platform 112 include without limitation: (1) entities can create a professional profile to showcase their skills, work experience, education, and professional accomplishments; (2) entities can connect with colleagues, industry professionals, and potential employers to expand their professional network; (3) messaging capabilities for direct communication between entities, facilitating professional conversations and networking opportunities; (4) entities can join and participate in industry-specific groups and communities to engage in discussions, share insights, and network with like-minded professionals; (5) search job listings and recruiting tools for entities to search for employment opportunities, apply for jobs, and connect with talent; (6) entities can share industry-related content, articles, and professional updates to showcase expertise and engage with their network; and (7) access learning resources, courses, and training programs to support ongoing professional development and skill enhancement. These networking services are designed to help professionals connect, collaborate, and grow their careers. Embodiments are not limited to these examples.

In an example process, the connection network platform 112 obtains activity data 130 from entities 108 via the client device 104. The entities 108 interact with the connection network platform 112 via an entity interface of the connection network platform 112. In some cases, portions of the entity interface are displayed on a personal machine or client device 104 of an entity 108. The activity data 130 represents various actions, activities or behaviors of one or more entities 108 of the entity 312. For example, activity data 130 may represent data collected as the entities 108 interact with various content items 134, such as organic content item 314, of the data store 126 served via the server device 102. In another example, the activity data 130 may represent data collected as the entities 108 interact with other products or services offered by the connection network platform 112, such as searching for job postings, sending messages to entities 108, recommending posts by entities 108, sending and responding to connection requests, playing online games, and other activities organic to use of the connection network platform 112. Session data is any activity data 130 collected during a defined session time window, such as activity of the entity over a 24 hour period or some other time interval. For example, an entity 108 of the entity 312 may interact with the client device 104 to communicate with the connection network platform 112 of one or more of the server devices 102 to access one or more content items 134 stored by the data store 126. The entities 108 may perform various activities, such as browsing a web site, searching for a job posting, reading content, watching a streaming video, messaging other members, clicking on an GUI item, interacting with an advertisements, or engaging in electronic commerce. The session data, including the activity data 130, is transferred between the client device 104 and the server device 102.

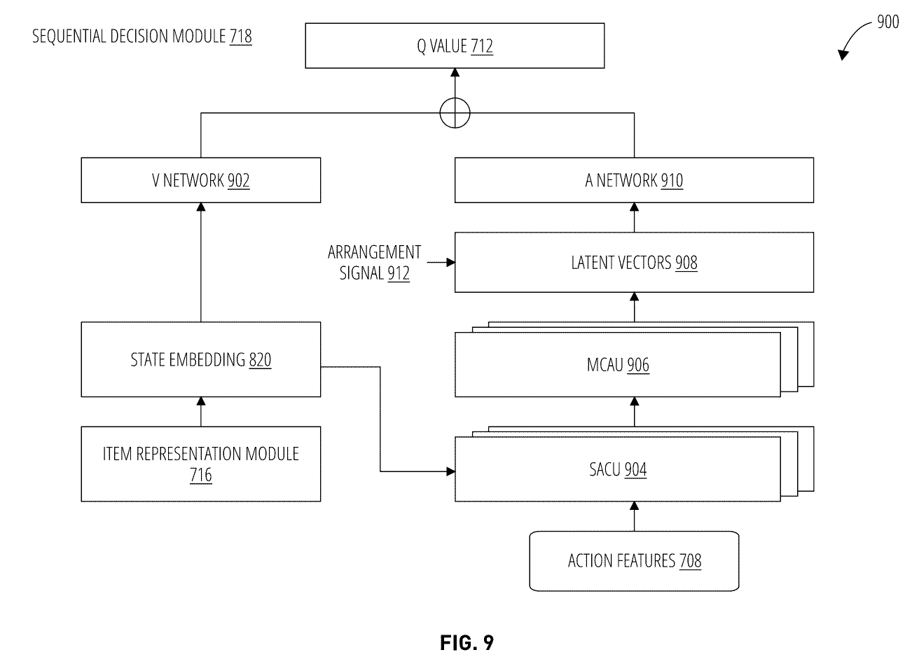

More particularly, the connection network platform 112 comprises the content delivery application 120, which includes or accesses an ML model 230, and data for one or more media channels 304. In particular embodiments, the content delivery system 300 uses multiple ML models 230 to support various downstream tasks for the content delivery application 120. One example of an ML model 230 is a multi-tower ML model to generate a metric for serving advertisements, such as a predicted click-through-rate (pCTR) as described with reference to FIG. 9. The content delivery application 120 uses the ML model 230 to support such activities. The content delivery application 120 then targets delivery of specific content items 134 to entities within entity segments, such as organic content items 314 for the entity 312, over one or more media channels 304. The targeted content is a content item that is relevant to the entity 312 or the entity 312 segment, such as messages, predictions, recommendations, advertisements, or suggestions to improve entity experience.

The targeted content is delivered through one or more of the media channels 304. A media channel refers to a specific platform or medium through which targeted content, such as advertisements, are disseminated to a target entity. Media channels 304 can include various forms of digital and traditional media such as websites, mobile applications, social media platforms, television, radio, print publications, and outdoor advertising spaces. Each media channel possesses its own unique characteristics and entity demographics, allowing advertisers to tailor their messages to reach the desired target entity effectively. message provider, such as advertisers, often choose certain media channels based on factors such as entity engagement, reach, cost, and the compatibility of the channel with their target market. An example of the media channel 304 is a social media platform or a professional media platform, or some other mode of information transfer within the platform.

The connection network platform 112 or components thereof are implemented on a server. A server provides one or more functions to entities linked by way of one or more of the various networks. In some cases, the server includes a single microprocessor board, which includes a microprocessor responsible for controlling all aspects of the server. In some cases, a server uses microprocessor and protocols to exchange data with other devices/entities on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

The data store 126 is an organized collection of data. For example, the data store 126 stores data in a specified format known as a schema. The data store 126 can be structured as a single database, a distributed database, multiple distributed databases, or an emergency backup database. In some cases, a database controller manages data storage and processing in data store 126. In some cases, an entity interacts with the database controller. In other cases, the database controller operates automatically without entity interaction. The data store 126 is configured to store various content items 134. The content items 134 include any multimedia information suitable for presentation by the client device 104, such as HTML code to present websites, text, images, video, messages, advertisements, and so forth. In addition, the data store 126 may also store application data comprising information and data used by the connection network platform 112. For example, data store 126is configured to store entity session data, profiles, embeddings, budgets, cached application programming interface (API) requests, machine learning model parameters, training data, and other data.

Network 106 facilitates the transfer of information between connection network platform 112, data store 126, and client device 104. Network 106 is a computer network configured to provide on-demand availability of computer system resources, such as data storage and computing power. In some examples, the network 106 provides resources without active management by the entities 108. The network 106 includes data centers available to many entities over the Internet. Some large cloud networks have functions distributed over multiple locations from central servers. A server is designated an edge server if it has a direct or close connection to an entities 108. In some cases, a cloud is limited to a single organization. In other examples, the cloud is available to many organizations. In one example, the network 106 includes a multi-layer communications network comprising multiple edge routers and core routers. In another example, the network 106 is based on a local collection of switches in a single physical location.

In particular embodiments, the content delivery system 300 uses multiple ML models 230 to support various downstream tasks for the content delivery application 120. For example, the content delivery application 120 may use an ML model 230 to use historical information about entities 302, activity data 130 for entities 302, content items 134, campaign attributes 310, and other types of historical information stored by the connection network system 100 to identify, select and deliver future content items 134 to the client device 104 of an entity 302 or entity 312.

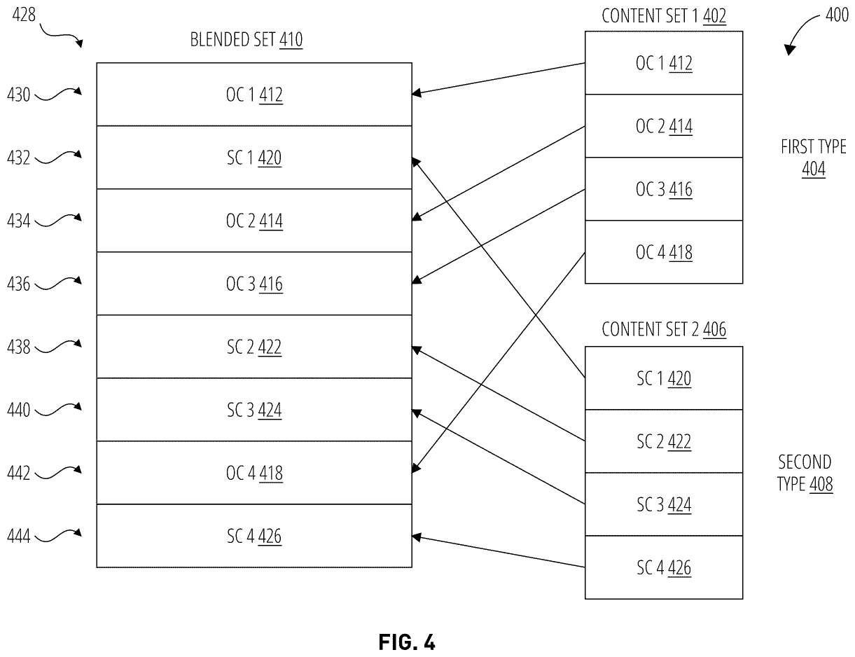

FIG. 4 illustrates a GUI view 400. The GUI view 400 is an example of a GUI view for the content feed 138 of the GUI 136. Embodiments are not limited to this example.

As depicted in FIG. 4, the GUI view 400 illustrates two types of content items 134. The content set 1 402 comprises content items 134 of a first type 404, such as organic content items 314. The content set 2 406 comprises content items 134 of a second type 408, such as sponsored content items 316. The blending algorithm 318 receives as input the content set 1 402 and the first type 404, and it selects organic content items 314 and sponsored content items 316 from each of the content set 1 402 and content set 2 406, respectively, and allocates each of the content items 134 to a content slot 428 of the content feed 138 to form a blended set 410. The content slots 428 may be for a page 446 of the content feed 138, such as section 1 448 and section 2 450. For example, the blending algorithm 318 may select an OC 1 412 from the content set 1 402 and allocate it to the slot 430, and then select a SC 1 420 from the content set 2 406 for allocation to the slot 432. The blending algorithm 318 continues the selection process by assigning OC 2 414 to slot 434, OC 3 416 to slot 436, SC 2 422 to slot 438, SC 3 424 to slot 440, OC 4 418 to slot 442, and SC 4 426 to slot 444. The blending algorithm 318 makes selections based on a number of factors, such as an entity identifier, entity data 128, entity activity data 130, a ratio of first type 404 to second type 408, historical data, objectives such as optimizing OC revenue and/or SC revenue, engagement metrics, pCTR values, and a host of other factors. Embodiments are not limited to these examples.

The output of the blending algorithm 318 results in a blended set 410 comprising a blend or mix of content items 134 of the first type 404 and the second type 408. The blending algorithm 318 interoperates with the content items 140 to determine which content slots 428 to assign content items 134 and when to assign the content items 134 to different sections, such as rendered sections and non-rendered sections of the content feed 138.

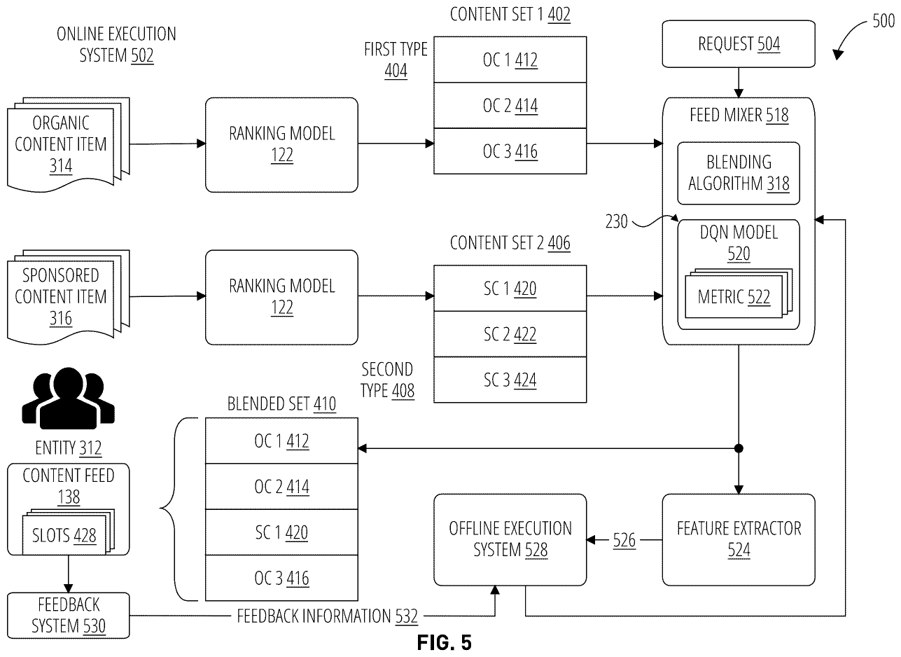

FIG. 5 illustrates a logic diagram 500. The logic diagram 500 is an example of components for a content delivery system 300, such as an online execution system 502 and an offline execution system 528. Embodiments are not limited to this example.

As previously described, embodiments are generally directed to AI and ML techniques to support various network services for an online connection network system 100. Some embodiments are particularly directed to a novel AI architecture and framework that implements various ML models 230 trained and deployed to perform inferencing operations in support of a network service 156. Non-limiting examples of network services 156 include feed services, search services, ranking services, recommendation services, advertising services, content delivery services, and other types of network services. In some embodiments, the AI and ML techniques are specifically used to improve feed services as discussed herein. However, embodiments are not limited to feed services, and can be applied to other network services as well. Embodiments are not limited in this context.

Some embodiments, for example, provide a technical solution to the feed placement technical problem of blending different types of data (e.g., OC and SC) in a content feed 138 of a connection network system 100 to optimize for a set of one or more objectives, such as an engagement objective (e.g., clicks, impressions, likes, etc.), a short term revenue objective, a long term revenue objective, a lifecycle revenue objective, a touchpoint objective, a recommendation objective, a ranking objective, and so forth. A content delivery system may implement a novel blending algorithm 318 to blend different types of content items 134 in the content feed 138. The blending algorithm 318 may use AI and ML techniques such as reinforcement learning to learn an action to take in different situations by testing different configurations of the content feed and measuring results. In particular, a reinforcement learning model learns from historical data, such as what types of content were shown to an entity, when they were shown to the entity, and how different entities (e.g., users) responded to the content. This learning approach helps the reinforcement learning model to make smarter decisions about when to show a particular type of content (e.g., OC or SC) in the content feed. This solution keeps entities engaged while optimizing for the given set of objectives.

More particularly, a connection network system 100 utilizes a content delivery system 300 to gain revenue via the content feed 138. The content feed 138 displays different content items 134 associated with different fee structures. For example, when an entity consumes an organic content item 314 there is one fee, and when the entity consumes a sponsored content item 316 there is another fee. Displaying more sponsored content items 316 is beneficial to SC revenue but harmful to OC revenue since sponsored content items 316 are less likely engaging than organic content items 314. Therefore, a number of sponsored content items 316 is limited in the content feed 138 to ensure a good user experience and engagement. Hence, how to allocate limited slots 428 reasonably and effectively to maximize overall revenue has become a very meaningful and challenging problem.

In some embodiments, the content delivery system 300 implements a feed mixer 518 (or blending server) utilizing a blending algorithm 318 to allocate content items 134 to the content feed 138. The feed mixer 518 takes an SC sequence, such as content set 2 406, and an OC sequence, such as content set 1 402, as input and it outputs a mixed sequence of the two, such as blended set 410. The blending algorithm 318 implements a dynamic slots strategy that adjusts a number and slots 428 of sponsored content items 316 according to the interest of entities. For instance, if an entity 312 has a higher tendency to consume sponsored content items 316, the blending algorithm 318 will allocate more sponsored content items 316 at conspicuous slots 428 to maximize possible benefits. Since the content feed 138 is presented to the entity in a sequence, the feed mixer 518 implements the dynamic slots strategy by modeling the problem as a Markov Decision Process (MDP) as discussed in detail herein, and solve it using reinforcement learning (RL).

Once the feed mixer 518 outputs a mixed sequence, such as blended set 410, it is displayed for the entity 312 on a client device 104. As the entity 312 interacts with the content feed 138 (e.g., views, clicks, impressions, implicit feedback, explicit feedback, etc.), feedback information 532 is generated for the feed mixer 518. For example, once a sponsored content item 316 is inserted into the content feed 138, a click-through rate (CTR) of surrounding organic content items 314 and 316 fluctuates. For example, inserting a sponsored content item 316 into the content feed 138 causes the CTR of organic content items 314 to increase while the CTR of sponsored content items 316 decreases. The fluctuating CTR is an arrangement signal which represents the influence of the arrangement of displayed content items 134 on user behaviors. The feed mixer 518 uses the arrangement signal as a basis for a better allocation strategy. As a result, the feed mixer 518 achieves an efficient balance between the personalization of different requests and the constraint on the percentage of advertisements (PAE) in a period. PAE is a notable constraint in sponsored content item 316 allocation, which balances the user experience and platform revenue.

Referring again to FIG. 5, the logic diagram 500 illustrates an online execution system 502 interoperating with an offline execution system 528 for the content delivery system 300. Generally, an online execution system 502 processes data in real-time or near-real-time, meaning it handles data as it is received or generated. This type of system is designed to provide immediate feedback, often in systems requiring low-latency responses such as real-time analytics, online recommendation engines, or AI models that need to adapt to live input. Online execution systems 502 continuously interact with external data sources, such as user inputs or sensor feeds, processing the incoming data dynamically to maintain up-to-date results. In contrast, an offline execution system 528 processes data in bulk at scheduled intervals, typically handling large volumes of pre-collected data rather than working in real-time. Feedback or results from an offline execution system 528 are not immediate; instead, they are provided after the entire batch of data has been processed. Offline execution systems 528 are commonly used in scenarios where immediate feedback is unnecessary, such as in historical data analysis, large-scale batch processing, or training machine learning models with static datasets. Offline execution systems 528 work with snapshots of data, offering more computational flexibility at the cost of real-time interaction.

In general operation, the logic diagram 500 illustrates components for an online execution system 502. The executes logic (e.g., hardware circuits or software instructions) for a ranking model 122, an OC 4 418, a blending algorithm 318, a DQN model 520, and a feature extractor 524. The ranking model 122 receives as input a set of organic content items 314 and sponsored content items 316. The ranking model 122 ranks the organic content items 314 into a ranked content set 1 402 of first type 404. The ranking model 122 also ranks the sponsored content items 316 into a ranked content set 2 406 of a second type 408. The content set 1 402 and content set 2 406 are input to the feed mixer 518. The feed mixer 518 receives a request 504 for content items to allocate to the slots 428 of the content feed 138. For example, the request 504 may be a call from an application program interface (API) indicating a start of a session between a client device 104 and an application of the connection network platform 112. The blending algorithm 318 of the feed mixer 518 blends the content set 1 402 and first type 404 to form a blended set 410. The blended set 410 is displayed on a content feed 138 of a GUI 136 on an electronic display of a client device 104. Individual content items from the blended set 410, comprising interleaved content items from the content set 1 402 and the content set 2 406, are assigned to corresponding slots 428 of the content feed 138. The entity 312 generates activity data 130 by interacting with the content feed 138, such as scrolling the content feed 138, viewing content items (e.g., impressions), clicking on hyperlinks (e.g., clicks), providing explicit feedback using feedback element 152, and so forth. A feedback system 530 records the activity data 130, and it sends it to the offline execution system 528 for further processing.

The blending algorithm 318 blends the content items 134 from the content set 1 402 and content set 2 406 using input from an ML model 230, such as the DQN model 520. The DQN model 520 is trained by the offline execution system 528 and deployed to the online execution system 502 to perform inferencing operations. During blending operations, the DQN model 520 generates a metric 522 for each of the content items 134 of the first type 404 and the second type 408. The blending algorithm 318 receives the metrics 522 as input, and it selects content items 134 of the first type 404 or the second type 408 from the content set 1 402 and content set 2 406, respectively, based on the metrics 522. In some embodiments, for example, the metrics 522 may comprise Q values. Embodiments are not limited to this example.

Specifically, the feed mixer 518 implements an ML model 230 to explicitly extract the arrangement signal. In some embodiments, the ML model 230 is a Deep Q Network (DQN), such as DQN model 520. The DQN model 520 uses a reinforcement learning algorithm that combine Q-learning with deep neural networks (DNN). The DQN model 520 uses neural networks to approximate a Q-value function, which predicts the expected future rewards of taking a certain action in a given state. By storing and randomly sampling past experiences, the DQN model 520 breaks the correlations between sequential data, stabilizing the learning process. Separate target networks are used to provide stable target Q-values during training, which helps in preventing oscillations and divergence.

In some embodiments, for example, the feed mixer 518 implements the DQN model 520 as a cross DQN. A cross DQN is a convolutional neural network (CNN) designed to map states and actions into values. The model takes a state (e.g., OC sequences, SC sequences, context information, etc.) and the corresponding candidate actions as the input. Then, an item representation module (IRM) generates the representations, particularly the representations of sponsored content items 316 and organic content items 314. Next, a sequential decision module (SDM) generates Q-values of different actions with the assistance of a state and action crossing unit (SACU), a multi-channel attention unit (MCAU), and an auxiliary loss for batch-level constraint. In the SACU, the state embeddings are intersected according to the action to form a unified matrix representation. In the MCAU, the crossing matrix generated from the SACU is split into different channels to calculate a multi-channel attention weight. Finally, the SDM selects the action with the largest Q-value. The feed mixer 518 uses the selected action to allocate an organic content item 314 or a sponsored content item 316 in a given slot of the slots 428 of the content feed 138.

For training operations of the DQN model 520, the online execution system 502 implements a feature extractor 524 to extract one or more features 526 for the DQN model 520. In machine learning, a feature 526 is an individual measurable property or characteristic used as an input to a predictive model. In more concrete terms, features 526 are how data is represented to the algorithm. For a dataset of images, for example, the raw pixels or some extracted properties (such as shape descriptors or color histograms) can serve as features 526. Good features 526 often help a model capture useful patterns, whether predicting outcomes in supervised learning or finding structure in unsupervised learning. Practitioners often transform or combine existing features 526 (e.g., taking logarithms, normalizing values, or combining multiple signals) to create new features 526 that can improve model performance. Ultimately, features 526 are the inputs that feed directly into the learning algorithm, such as columns in a spreadsheet or data file representing numerical, textual, or categorical variables. Well-crafted features 526, and effective feature engineering, can significantly influence the overall performance of the DQN model 520. The feature extractor 524 extracts certain features 526 for the DQN model 520, and it sends the features 526 to the offline execution system 528 for training operations for the DQN model 520.

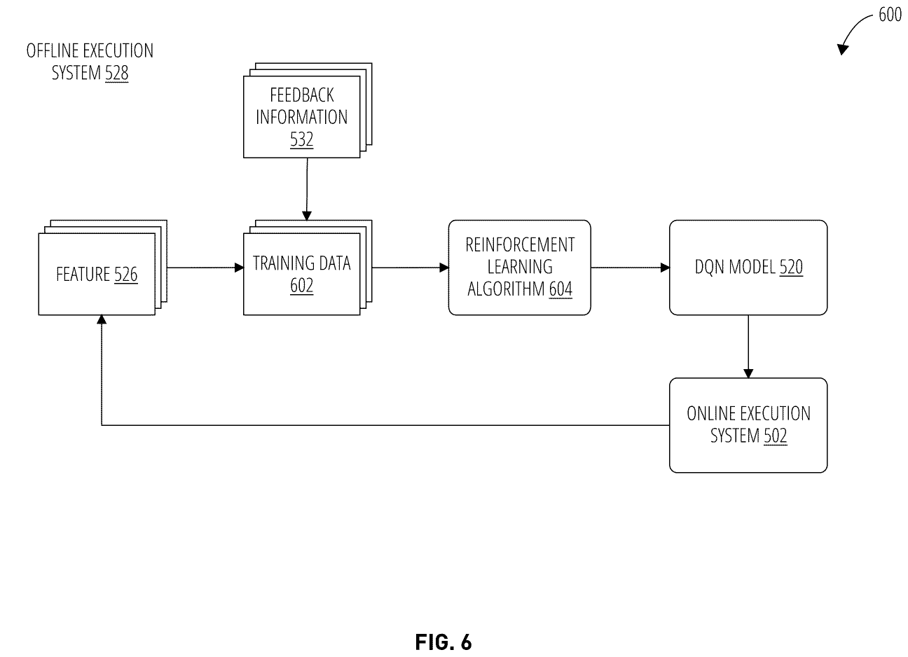

FIG. 6 illustrates a logic diagram 600. The logic diagram 600 is an example of an offline execution system 528 for a content delivery system 300. Embodiments are not limited to this example.

While effective, the DQN model 520 consumes a significant amount of resources to train and it also introduces latency when performing inferencing operations. In some cases, these constraints are not suitable for the online execution system 502. The content delivery system 300 of the connection network system 100 may service millions of entities around the world simultaneously, constantly updating content feeds 138 for the entities 312 with new organic content items 314 and sponsored content items 316 in different geographic locations. As such, implementing the DQN model 520 for a large-scale industrial online system can be challenging.

To address this technical problem, the content delivery system 300 implements two different execution pipelines, such as the online execution system 502 and the offline execution system 528. As previously described with reference to FIG. 5, the online execution system 502 performs feed services in real-time or near real-time. In some embodiments, the online execution system 502 performs inferencing operations for the feed mixer 518 using a trained ML model 230 such as the DQN model 520 or a cross DQN model. For example, when an entity 312 starts a session with the connection network system 100, the content delivery system 300 begins serving organic content items 314 and sponsored content items 316 in the content feed 138 for the session using the online execution system 502.

The offline execution system 528 performs background tasks to support the online execution system 502. For example, the offline execution system 528 may train ML models 230, update databases and indices, retrieve and store data, and other tasks. In some cases, these tasks can take hours, days, or even weeks to accomplish. In particular, the offline execution system 528 performs training operations for the ML model 230, and it then writes the ML model 230 to the online execution system 502 for inferencing operations. The ML model 230 may be trained or retrained on a regular basis, such as daily, weekly, or monthly, depending on model training time and available training data. Even while bifurcating these functions, however, the DQN model 520 may still be too large to perform inferencing operations within latency constraints for the online execution system 502. Therefore, some embodiments use several techniques to solve this technical problem, such as reducing dimensions for the model using embeddings, using defined thresholds during online serving, and using backup models in case the primary model fails.

As depicted in FIG. 6, the logic diagram 600 collects features 526 and feedback information 532 from the online execution system 502, and stores the collected data as training data 602. The offline execution system 528 implements a reinforcement learning algorithm 604 that receives as input training data points from the training data 602 and trains (or re-trains) the DQN model 520 using the training data 602. The RL policy is trained offline and off-policy, which implies the policy learning relies on adequate exploration from the behavior policy. The offline execution system 528 deploys the trained (or re-trained) DQN model 520 to the online execution system 502. During online serving, besides following the RL policy, epsilon exploration is applied to randomly make decisions on whether to display organic content items 314 or sponsored content items 316.

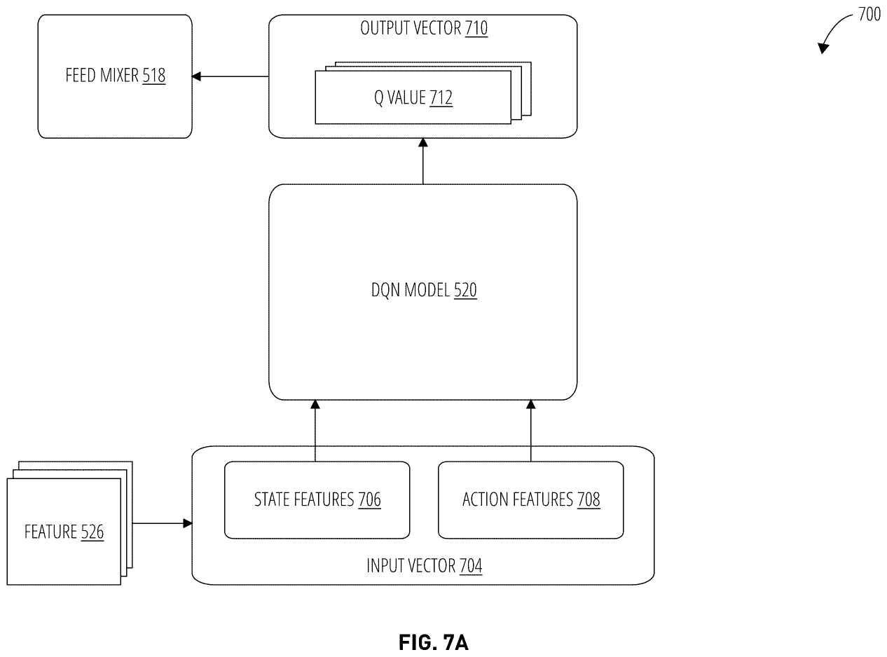

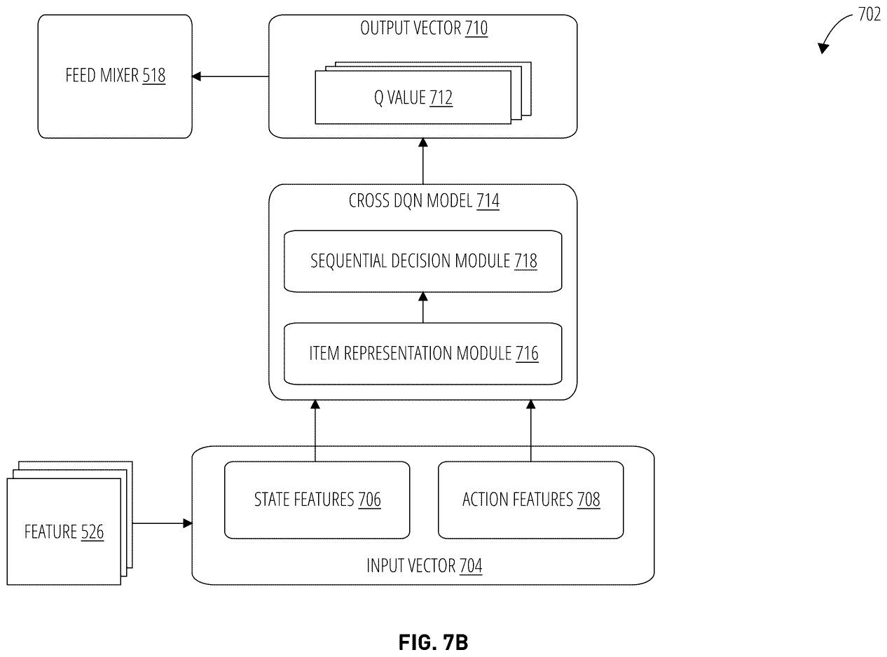

FIG. 7A illustrates an ML architecture 700. The ML architecture 700 is an example architecture or framework for a DQN model 520 of a feed mixer 518 of an online execution system 502 of a content delivery system 300 for a connection network platform 112 of a connection network system 100. Embodiments are not limited to this example.

Since the content feed 138 is presented to the entity in a sequence, the feed mixer 518 implements the dynamic slots strategy by modeling the technical problem as a Markov Decision Process (MDP) as discussed in detail herein, and solve it using reinforcement learning (RL).

This technical problem can be modeled as an MDP, with states S, actions A, transition probability P, and reward function R. To be more rigorous, it is a partially observable MDP because members' mental states cannot be observed, and is therefore simplified as MDP as the mathematical formulation can be transferred. The MDP comprises five elements (S, A, P, R, γ). For States S, s∈S contains static member features (e.g. demographic), some dynamic features (e.g. time of the day), and summaries of member historical behaviors (e.g. past feeds shown and member's reaction).

It can be constructed as (u, ((x₁, y₁), (x₂, y₂), . . . , (x_{T}, x_{T})), c), where u denotes the member information, x contains the set of feeds (both organic and sponsored) sent to the entity 312 at each time, y contains the entity 312 responses/feedback, and c contains the information of the next feed (both organic and sponsored) in the queue.

The state set also contains a terminate state, which implies that the entity 312 will not be returning to connection network platform 112 within a certain time window. For example, if the entity 312 has viewed 10 feeds, and did not return within the next 24 hours, then a terminal state is appended after (x₁, y₁), (x₂, y₂), . . . , (x₁₀, y₁₀), indicating no more transition/reward after reaching a terminal state. Note that this dataset is limited in that there are no records of when the system sent a completely different set of feeds, and online exploration may be considered.

For the actions A, α∈A only has two values, show SU or show OU.

For the transition probability P(s′|s, α) reflects the probability of the state becoming s′ when action α is taken at s. If s is the terminal state, then the next state will be the terminal state with a probability of 1.

For the reward function, R(s, α) is the expected reward. In this case, with an objective to maximize the expected revenue, R(s, α) will be the eCPI of the content delivery campaign 308 (e.g., supporting eCPI or reserve price, simplified as eCPI), where if α=show ad, and 0 otherwise. If s is the terminal state, then reward is set to 0.

For the discount factor, γ: γ∈[0, 1] is introduced to measure the present value of future reward. Under the setting that only considers immediate reward, γ can be set to 0. Therefore, γ can be used as a leverage of long-term VS short term revenue.

The cumulative reward given a policy π: S→A can be written as shown in Equation (1):

$$R ( {s}_{0} , π ( {s}_{0} ) ) + {\sum }_{{s}_{1} ∈ S} γ \cdot R ( {s}_{1} , π ( {s}_{1} ) ) \cdot P ( {s}_{1} \vert {s}_{0} , π ( {s}_{0} ) ) + … \qquad EQUATION ( 1 )$$

In Equation (1), s₀ is the initial state. To write it recursively, the value function can then be written as Equation (2):

$$V π ( {s}_{0} ) = R ( s , π ( {s}_{0} ) ) + γ {\sum }_{{s}^{′} ∈ S} P ( {s}^{′} \vert {s}_{0} , π ( {s}_{0} ) ) \cdot {V}^{π} ( {s}^{′} ) \qquad EQUATION ( 2 )$$

One goal is to learn an optimal policy π, that maximizes the expected value function π*=argmax_{π}E[R|π]. One approach to solve RL problems is Q-learning, a model-free algorithm to learn the Q function. The Q function gives the value of taking an action α at state s, then acting according to policy, which can be expressed as Equation (3):

$${Q}^{π} ( s , a ) = R ( s , a ) + γ {\sum }_{{s}^{′} ∈ S} P ( {s}^{′} \vert {s}_{0} , a ) \cdot {V}^{π} ( {s}^{′} ) \qquad EQUATION ( 3 )$$

After learning the Q-function, the feed mixer 518 can decide an optimal action (place OC or SC) depending on the current state. The DQN model 520 is designed to learn the Q-function.

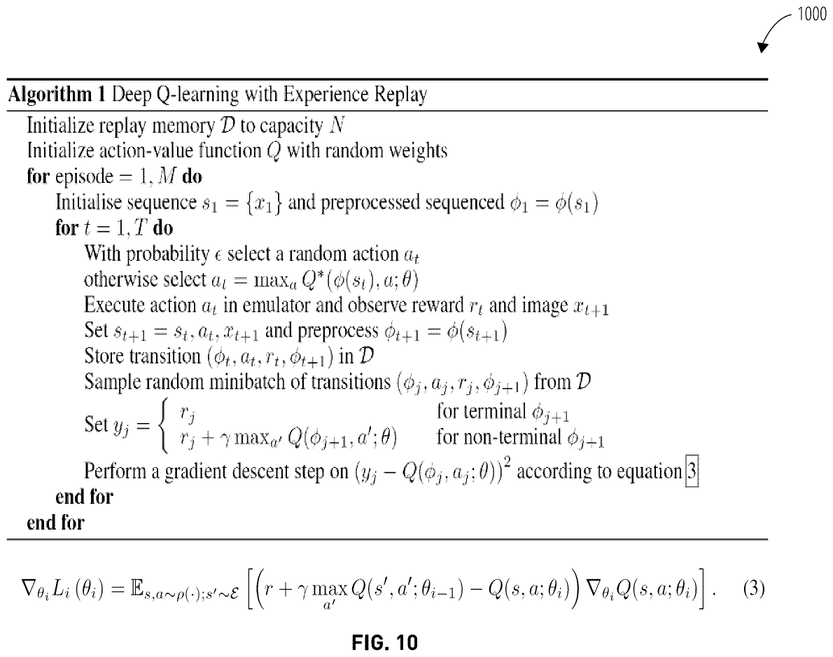

The offline execution system 528 is used to train the DQN model 520 to learn the Q-function. Referring again to FIG. 7A, the ML architecture 700 illustrates a set of features 526 constructed as an input vector 704 with state features 706 and action features 708. The DQN model 520 receives the input vector 704 as input, generates a set of Q values 712, and outputs an output vector 710 with the set of Q values 712. The DQN model 520 uses a convolutional neural network (CNN) to map the state features 706 (s_t) and action features 708 (a_t) into a Q value such as Q(s_t, a_t). The DQN model 520 is a model-free, off-policy method, which does not need the knowledge of probability transition models. Instead, it uses an experience replay mechanism to sample the training data 602. The DQN model 520 is trained based on historical tracked data, which contains activity data 130 of entities 312 interacting with the content feed 138, including one or both of organic content items 314 and sponsored content items 316. An algorithm for the DQN model 520 is described in more detail with reference to FIG. 10.

The Q values 712 are input to the feed mixer 518. The blending algorithm 318 of the feed mixer 518 uses the Q values 712 as metrics 522 to select a next organic content item 314 or sponsored content item 316 for the blended set 410.

FIG. 7B illustrates an ML architecture 702. The ML architecture 702 is an example architecture or framework for a DQN model 520 of a feed mixer 518 of an online execution system 502 of a content delivery system 300 for a connection network platform 112 of a connection network system 100. Embodiments are not limited to this example.

Although using the offline execution system 528 to train the DQN model 520 for deployment to the online execution system 502, the dimensions of the DQN model 520 may so large as to prevent completion of inferencing operations within latency constraints of the online execution system 502. The DQN model 520 may be called N times, where N is the number of available feeds within a request, which is time-consuming given the large size of the states. Therefore, to address this technical problem, some embodiments decompose the DQN model 520 into different parts, such as an item representation module 716 and a sequential decision module 718 for deployment. The item representation module 716 generates representations of feeds. In particular, it generates state embeddings from a raw state, one for organic content items 314 and one for sponsored content items 316. The sequential decision module 718 generates Q values 712 of different actions, based on the ranked content set 1 402 of organic content items 314, features 526 for the sponsored content items 316, and embeddings from the item representation module 716.

The two parts are trained offline end-to-end. However, they are deployed separately for the online execution system 502 to reduce the latency. The item representation module 716 can be computed in parallel with ranking models 122 for the organic content items 314 and sponsored content items 316. Therefore, the only additional latency introduced into the online execution system 502 is the sequential decision module 718 inferencing operation, which is relatively small and normally within the latency constraints of the online execution system 502.

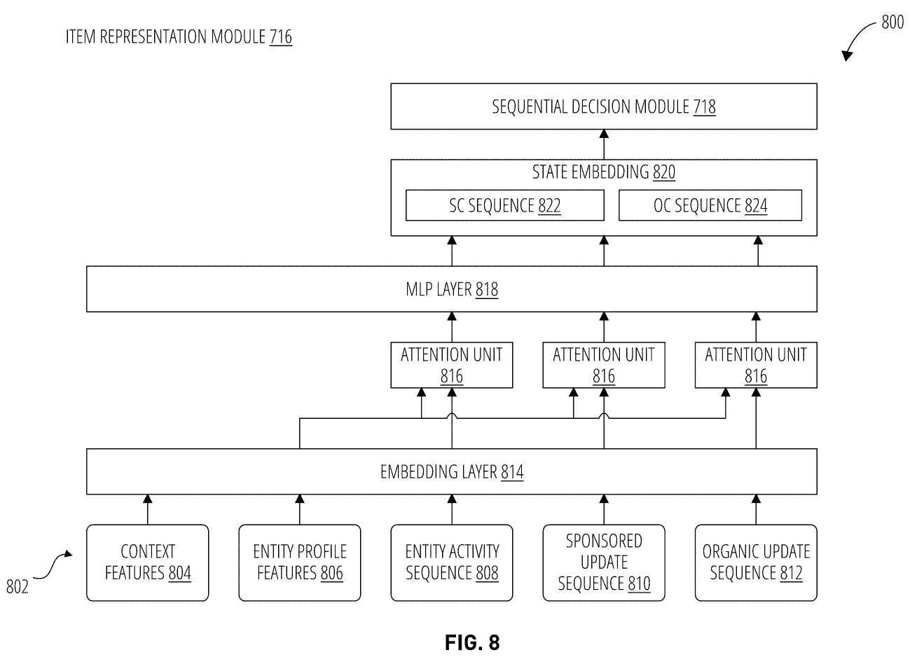

FIG. 7B depicts an ML architecture 702 with an example of a decomposed DQN model 520 referred to as a cross DQN model 714. Similar to the ML architecture 700 of FIG. 7A, the ML architecture 702 illustrates a set of features 526 constructed as an input vector 704 with state features 706 and action features 708. The cross DQN model 714 receives the input vector 704 as input, and it outputs an output vector 710 with a set of Q values 712. The item representation module 716 processes the state features 706 and action features 708 of the input vector 704, and it generates the state embedding based on the raw state. It outputs the results to the sequential decision module 718. The sequential decision module 718 generates Q-values of different actions with the help of a state and action crossing unit (SACU), multi-channel attention unit (MCAU) and auxiliary loss for batch-level constraint. A more detailed example of the item representation module 716 is described with reference to FIG. 8. The sequential decision module 718 processes the results, and it generates a set of Q values 712 for the output vector 710. A more detailed example of the sequential decision module 718 is described with reference to FIG. 9.

As depicted in ML architecture 702, the DQN model 520 is decomposed into the item representation module 716 and the sequential decision module 718 for deployment by the online execution system 502. The offline execution system 528 trains the item representation module 716 and the sequential decision module 718 end-to-end. The offline execution system 528 deploys the item representation module 716 and sequential decision module 718 as separate models for the online execution system 502 to reduce latency associated with inferencing operations.

The output vector 710 are input to the feed mixer 518. The blending algorithm 318 of the feed mixer 518 uses the Q values 712 as metrics 522 to select a next organic content item 314 or sponsored content item 316 for the blended set 410.

FIG. 8 illustrates an ML architecture 800. The ML architecture 800 is an example of an ML architecture or ML framework suitable for implementing the cross DQN model 714 as described with reference to FIG. 7B. The cross DQN model 714 extracts cross information between an action and a state. Specifically, the ML architecture 800 depicts an example of an item representation module 716 for a cross DQN model 714. Embodiments are not limited to this example.

As previously described with reference to FIG. 7A and FIG. 7B, the ML architecture 702 illustrates a set of features 526 constructed as an input vector 704 with state features 706 and action features 708. The cross DQN model 714 receives the input vector 704 as input, and it outputs an output vector 710 with a set of Q values 712. The item representation module 716 processes the state features 706 and action features 708 of the input vector 704, and it generates the state embedding based on the raw state. It outputs the results to the sequential decision module 718. The sequential decision module 718 generates Q-values of different actions with the help of a state and action crossing unit (SACU), multi-channel attention unit (MCAU) and auxiliary loss for batch-level constraint.

As depicted in FIG. 8, the ML architecture 800 comprises an input layer 802 comprising context features 804, entity profile features 806, entity activity sequence 808, sponsored update sequence 810, and organic update sequence 812. The cross DQN model 714 takes a state (including organic content items 314 and sponsored content items 316 sequences, context features 804, etc.) and the corresponding candidate actions as the input. The item representation module 716 generates the representations, particularly the representations of sponsored content items 316 and organic content items 314.

The embedding layer 814 generates a state embedding from the raw states of input layer 802, which includes state features 706. To efficiently process the information from different sources, the item representation module 716 generates two sequences of mixed embeddings, the first for sponsored content items 316 and the second for organic content items 314. The embedding for each item encodes not only the information of the item itself but also the information of the entity data 128 (e.g., user profile), the context, and the interaction with historical user behaviors. The embedding layer 814 extracts the embeddings from the raw inputs of the input layer 802. A set of target attention units 816 to encodes an interaction between the historical behaviors of the entity 312 and a corresponding item. Afterwards, the MLP layer 818 appends the embeddings of the entity data 128 and the context to the embedding of each item to form state embedding 820. The state embedding 820 comprises a SC sequence 822 and an OC sequence 824. Involving several attention units, the item representation module 716 may incur significant latency during inferencing operations. However, the item representation module 716 is an independent module within the cross DQN model 714 and therefore it can be invoked in parallel to other modules upstream from the cross DQN model 714.

The item representation module 716 outputs the state embedding 820 to the sequential decision module 718 for further processing. The sequential decision module 718 is described in more detail with reference to FIG. 9.

FIG. 9 illustrates an ML architecture 900. The ML architecture 900 is an example of an ML architecture or ML framework suitable for implementing the cross DQN model 714 as described with reference to FIG. 7B. The cross DQN model 714 extracts cross information between an action and a state. Specifically, the ML architecture 900 depicts an example of a sequential decision module 718 for a cross DQN model 714. Embodiments are not limited to this example.

As depicted in FIG. 9, the ML architecture 900 illustrates the item representation module 716 outputting a state embedding 820 to a V network 902. The item representation module 716 also outputs the state embedding 820 to the sequential decision module 718.

The sequential decision module 718 generates Q-values of different actions with the help of a state and action crossing unit (SACU), multi-channel attention unit (MCAU) and auxiliary loss for batch-level constraint. To evaluate a Q value of a certain state-action pair, there needs to be an efficient representation of the mixed list designated by the corresponding action. For a given set of action features 708, the SACU 904 constructs a sequence of embeddings corresponding to the mixed list from the state embedding 820. The embedding for the mixed list enables the sequential decision module 718 to extract the arrangement signal in the next module.

An entity 312 may focus on one or more aspects (e.g., discount, delivery fee, delivery time) of the mixed sequence at the same time. Accordingly, the MCAU 906 simultaneously models the attention of the entity 312 to different aspects of the mixed sequence. The SACU 904 generates a cross matrix containing different channels. Each channel represents an information dimension in the latent space and can be used to model one aspect of the mixed sequence. Meanwhile, the entity 312 may pay attention to more than one aspect of the mixed sequence at the same time. The MCAU 906 combines the sequence information of two or more channels for modeling, and it outputs a set of latent vectors 908.

Using the SACU 904 and MCAU 906, the sequential decision module 718 takes the state embeddings 820 generated by the item representation module 716 and candidate actions represented by the action features 708 as input. The sequential decision module 718 outputs Q values 712. Given a set of candidate actions, the SACU 904 generates a cross matrix for each action and the MCAU 906 generates corresponding arrangement signal representation for each action as latent vectors 908. Subsequently, the sequential decision module 718 calculates Q values 712 from the outputs of the V network 902 and A network 910.

FIG. 10 illustrates a training algorithm 1000. The connection network system 100 is an example of a training algorithm suitable for the DQN model 520 and/or the cross DQN model 714. Embodiments are not limited to this example.

As previously described, the DQN model 520 uses a convolutional neural network (CNN) to map state and action into a value. It uses a model-free, off-policy method that does not necessarily need the knowledge of probability transition models. Instead, it uses an experience replay mechanism to sample the training data 602. The training algorithm 1000 is an example of a deep Q-learning with experience replay training algorithm. The training algorithm 1000 utilizes an experience replay technique, where experiences for each time step are stored in a data set, and pooled over many episodes into a replay memory. An inner loop of the training algorithm 1000 applies Q-learning updates, or minibatch updates, to samples of experience drawn at random from the pool of stored samples. After performing experience replay, an agent selects and executes an action according to a greedy policy. The Q-function uses fixed length representation of histories produced by a function.

The training algorithm 1000 stores the last N experience tuples in the replay memory, and it samples uniformly at random from the replay memory D when performing updates. Additionally, or alternatively, the training algorithm 1000 may use a sampling strategy that emphasizes transitions providing the most information, similar to prioritized sweeping.

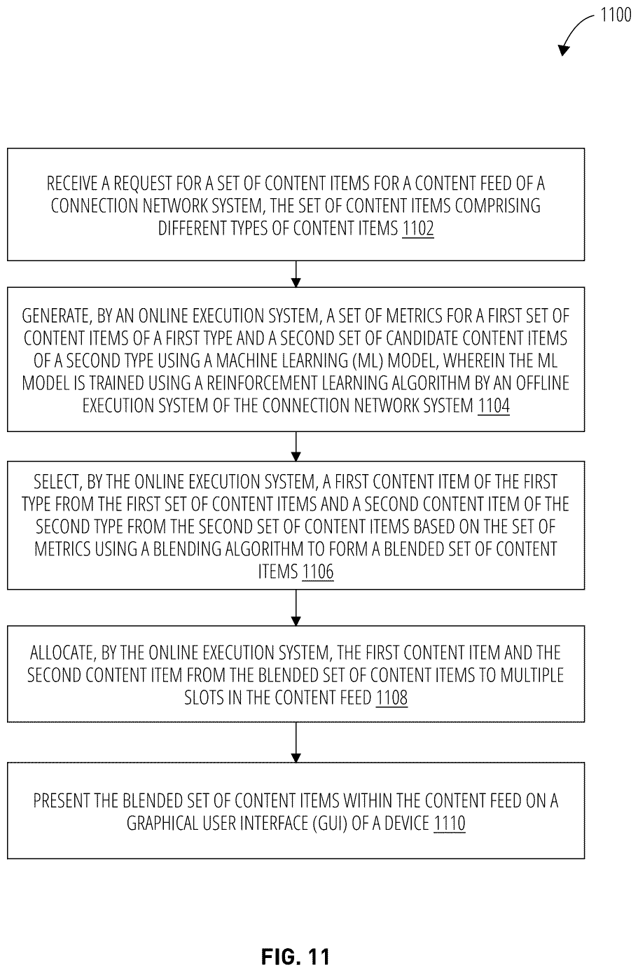

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the connection network platform 112 of the connection network system 100, such as the server device 102 and/or the client device 104. More particularly, the logic flow 1100 illustrates an example where the server device 102 performs a set of training and/or inferencing operations of a ML model such as an ML model 230 to support one or more network services 156 provided by the connection network platform 112 of the connection network system 100. For example, the logic flow 1100 may be performed by the server device 102 and/or the client device 104 using a system 200, content delivery system 300, GUI view 400, logic diagram 500, logic diagram 600, ML architecture 700, ML architecture 800, ML architecture 900, and/or training algorithm 1000.

As depicted in logic flow 1100, at block 1102 the logic flow 1100 includes receiving a request for a set of content items for a content feed of a connection network system, the set of content items comprising different types of content items. At block 1104, the logic flow 1100 includes generating, by an online execution system, a set of metrics for a first set of content items of a first type and a second set of candidate content items of a second type using a machine learning (ML) model, wherein the ML model is trained using a reinforcement learning algorithm by an offline execution system of the connection network system. At block 1106, the logic flow 1100 includes selecting, by the online execution system, a first content item of the first type from the first set of content items and a second content item of the second type from the second set of content items based on the set of metrics using a blending algorithm to form a blended set of content items. At block 1108, the logic flow 1100 includes allocating, by the online execution system, the first content item and the second content item from the blended set of content items to multiple slots in the content feed. At block 1110, the logic flow 1100 includes presenting the blended set of content items within the content feed on a graphical user interface (GUI) of a device.

By way of example, the online execution system 502 receives a request 504 for a set of content items 134 for a content feed 138 of a connection network system 100. The set of content items 134 comprise different types of content items, such as organic content items 314 of a content set 1 402 of a first type 404 and sponsored content items 316 of a content set 2 406 of a second type 408. An ML model 230 such as DQN model 520 generates a set of metrics 522 for a content set 1 402 of a first type 404 and a content set 2 406 of a second type 408. The DQN model 520 is trained using a reinforcement learning algorithm 604 by an offline execution system 528 of the connection network system 100. A blending algorithm 318 of the feed mixer 518 selects a first content item, such as OC 1 412, of the first type 404 from the content set 1 402, and a second content item, such as SC 1 420, of the second type 408 from the OU 1 506 based on the set of metrics 522 to form a blended set of content items, such as blended set 410. The feed mixer 518 allocates the first content item (e.g., OC 1 412) and the second content item (e.g., SC 1 420) from the blended set of content items (e.g., blended set 410) to multiple slots 428 in the content feed 138. The online execution system 502 presents the blended set 410 within the content feed 138 on a GUI 136 of a client device 104.

In some embodiments, for example, the first type 404 may comprise an organic content item 314 and the second type 408 may comprise a sponsored content item 316.

In some embodiments, for example, the ML model 230 is a DQN model 520. The DQN model 520 may receive an input vector 704 comprising state features 706 and action features 708. The DQN model 520 generates an output vector 710 comprising the set of metrics 522. The set of metrics may comprise Q values 712. The DQN model 520 outputs the set of metrics 522 to the blending algorithm 318 of a feed mixer 518.

In some embodiments, for example, the ML model 230 is a cross DQN model 714 comprising an item representation module 716 and a sequential decision module 718. The item representation module 716 receives a set of features 526 by an input layer 802 of the item representation module 716. The set of features 526 may comprise context features 804, entity profile features 806, an entity activity sequence 808, a sponsored update sequence 810, and an organic update sequence 812. An embedding layer 814 of the item representation module 716 generates a state embedding 820 from the set of features 526, and it outputs the state embedding 820 to the sequential decision module 718. The sequential decision module 718 receives the state embedding 820 from the item representation module 716 as an input to a V network 902 of the sequential decision module 718. The sequential decision module 718 receives a set of candidate actions (e.g., action features 708) as an input (e.g., latent vectors 908), via one or more SACUs 904 and MCAUs 906, to an A network 910. The sequential decision module 718 generates a set of Q values 712 corresponding to the set of candidate actions, and it outputs the set of Q values 712 to the blending algorithm 318 of a feed mixer 518.

In some embodiments, for example, a feedback system 530 receives feedback information 532 from the GUI 136 of the client application 110 associated with an arrangement of content items, such as the organic content items 314 and sponsored content items 316 of the blended set 410, within the content feed 138 by the online execution system 502. The training device 1302 retrains the ML model 230 using the reinforcement learning algorithm 604 and the feedback information 532 by the offline execution system 528. The training device 1302 deploys the retrained ML model 230 to the online execution system 502 for inferencing operations.

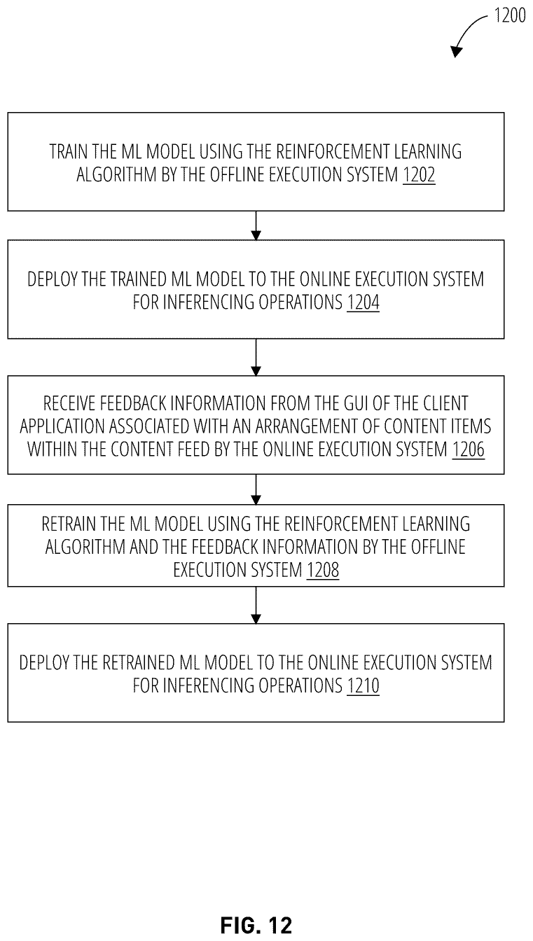

FIG. 12 illustrates an embodiment of a logic flow 1200. The logic flow 1200 may be representative of some or all of the operations executed by one or more embodiments described herein. For example, the logic flow 1200 may include some or all of the operations performed by devices or entities within the connection network platform 112 of the connection network system 100, such as the server device 102 and/or the client device 104. More particularly, the logic flow 1100 illustrates an example where the server device 102 performs a set of inferencing operations of a ML model such as a generative AI model to support one or more network services 156 provided by the connection network platform 112 of the connection network system 100. For example, the logic flow 1100 may be performed by the server device 102 and/or the client device 104 using a system 200, content delivery system 300, GUI view 400, logic diagram 500, logic diagram 600, ML architecture 700, ML architecture 800, ML architecture 900, and/or training algorithm 1000.

As depicted in logic flow 1200, at block 1202, the logic flow 1200 trains the ML model using the reinforcement learning algorithm by the offline execution system. At block 1204, the logic flow 1200 deploys the trained ML model to the online execution system for inferencing operations. At block 1206, the logic flow 1200 receives feedback information from the GUI of the client application associated with an arrangement of content items within the content feed by the online execution system. At block 1208, the logic flow 1200 retrains the ML model using the reinforcement learning algorithm and the feedback information by the offline execution system. At block 1210, the logic flow 1200 deploys the retrained ML model to the online execution system for inferencing operations.

By way of example, the training device 1302 trains the ML model 230, such as DQN model 520 and/or cross DQN model 714, using the reinforcement learning algorithm 604 by the offline execution system 528. The training device 1302 deploys the trained ML model 230 to the online execution system 502 for inferencing operations. In some embodiments, for example, the training device 1302 trains the item representation module 716 and the sequential decision module 718 of the cross DQN model 714 using the reinforcement learning algorithm 604 by the offline execution system 528. The training device 1302 deploys the item representation module 716 and the sequential decision module 718 of the cross DQN model 714 as separate sub-models in the online execution system 502 to generate the metrics 522.

FIG. 13 illustrates an apparatus 1300. The apparatus 1300 depicts a training device 1302 suitable for training an ML model 1320 for the connection network system 100. Specifically, the training device 1302 trains the ML model 1320 to perform inferencing operations in support of the content delivery application 120, ranking model 122, or recommendation model 124.

As depicted in FIG. 13, the training device 1302 includes a processing circuitry 1304 and a memory unit 1306. The memory unit 1306 may store a set of ML components 1308 to support various AI/ML techniques. The ML components 1308 comprise a data collector 1310, a model trainer 1312, a model evaluator 1314 and a model inferencer 1316.

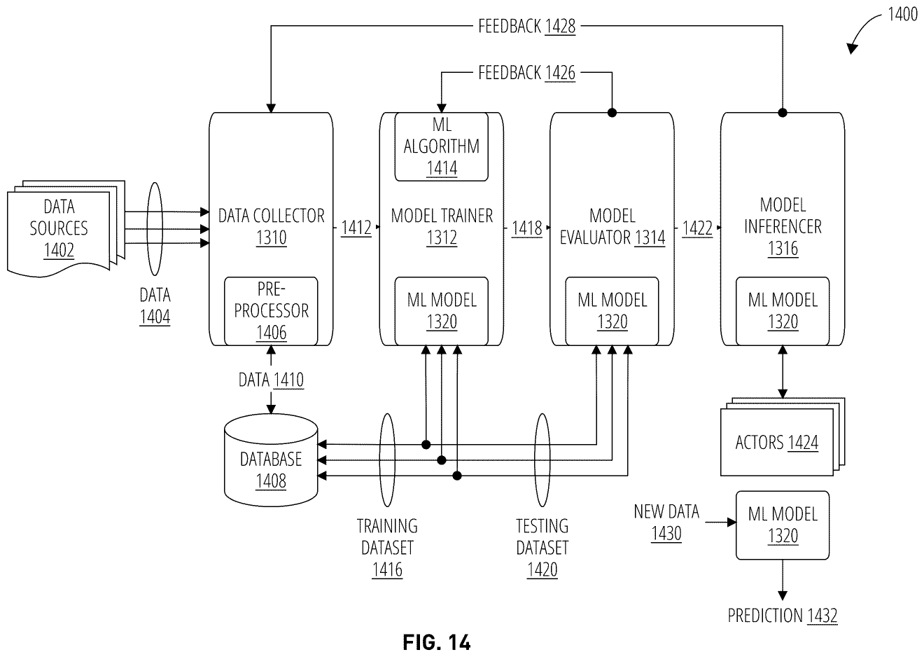

In general, the data collector 1310 collects data 1318 from one or more data sources to use as training data for an ML model 1320. The data collector 1310 collects different types of data 1318, such as text information, audio information, image information, video information, graphic information, and so forth. The model trainer 1312 receives as input the collected data and uses a portion of the collected data as test data for an AI/ML algorithm to train the ML model 1320. The model evaluator 1314 evaluates and improves the trained ML model 1320 using a portion of the collected data as test data to test the ML model 1320. The model evaluator 1314 also uses feedback information from the deployed ML model 1320. The model inferencer 1316 implements the trained ML model 1320 to receive as input new unseen data, generate one or more inferences on the new data, and output a result such as an alert, a recommendation or other post-solution activity. An exemplary AI/ML architecture for the ML components 1308 is described in more detail with reference to FIG. 14.

FIG. 14 illustrates a logic diagram 1400 suitable for use by the training device 1302 to generate the ML model 1320 for deployment by an inferencing device of the connection network platform 112. The logic diagram 1400 is an example of a system suitable for implementing various AI techniques and/or ML techniques to perform various training tasks on behalf of the various devices of the connection network system 100.

In one embodiment, the training device 1302 trains an ML model 1320. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 1302 may pretrain an ML model 1320 before training the ML model 1320 or trains a pretrained ML model 1320. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 1400 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1320, evaluate performance of the trained ML model 1320, and deploy the tested ML model 1320 as the trained ML model 1320 in a production environment, and continuously monitor and maintain it.

The ML model 1320 is a mathematical construct used to predict outcomes based on a set of input data. The ML model 1320 is trained using large volumes of training dataset 1416, and it can recognize patterns and trends in the training dataset 1416 to make accurate predictions. The ML model 1320 is derived from an ML algorithm 1414. A data set is fed into the ML algorithm 1414 which trains an ML model 1320 to “learn” a function that produces mappings between a set of inputs and a set of outputs with a reasonably high accuracy. Given a sufficiently large enough set of inputs and outputs, the ML algorithm 1414 finds the function for a given task. This function may even be able to produce the correct output for input that it has not seen during training. A data scientist prepares the mappings, selects and tunes the ML algorithm 1414, and evaluates the resulting model performance. Once the ML model 1320 is sufficiently accurate on test data, it can be deployed for production use.

The ML algorithm 1414 is generally a computational procedure used to identify patterns within data and make inferences or predictions without being explicitly programmed for every scenario. The ML algorithm 1414 can process input data, learn from it by adjusting internal parameters, and then apply the learned information to new, unseen data. The ML algorithm 1414 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1414 of the logic diagram 1400 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naïve Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 14, the logic diagram 1400 includes a set of data sources 1402 to source data 1404 for the training device 1302. Data sources 1402 may comprise any device capable generating, processing, storing or managing data 1404 suitable for a ML system. Examples of data sources 1402 include without limitation databases, web scraping, sensors and Internet of Things (IoT) devices, image and video cameras, audio devices, text generators, publicly available databases, private databases, and many other data sources 1402. The data sources 1402 may be remote from the training device 1302 and accessed via a network, local to the training device 1302 and accessed via a network interface, or may be a combination of local and remote data sources 1402.

The data sources 1402 source difference types of data 1404. By way of example and not limitation, the data 1404 includes structured data from relational databases, such as customer profiles, transaction histories, or product inventories. The data 1404 includes unstructured data from websites such as customer reviews, news articles, social media posts, or product specifications. The data 1404 includes data from temperature sensors, motion detectors, and smart home appliances. The data 1404 includes image data from medical images, security footage, or satellite images. The data 1404 includes audio data from speech recognition, music recognition, or call centers. The data 1404 includes text data from emails, chat logs, customer feedback, news articles or social media posts. The data 1404 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1404 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1402 are communicatively coupled to a data collector 1310. The data collector 1310 gathers relevant data 1404 from the data sources 1402. Once collected, the data collector 1310 may use a pre-processor 1406 to make the data 1404 suitable for analysis. This involves data cleaning, transformation, and feature engineering. Data preprocessing is a critical step in ML as it directly impacts the accuracy and effectiveness of the ML model 1320. The pre-processor 1406 receives the data 1404 as input, processes the data 1404, and outputs pre-processed data 1410 for storage in a database 1408. Examples for the database 1408 includes a hard drive, solid state storage, and/or random access memory (RAM).

The data collector 1310 is communicatively coupled to a model trainer 1312. The model trainer 1312 performs AI/ML model training, validation, and testing which may generate model performance metrics as part of the model testing procedure. The model trainer 1312 receives the pre-processed data 1410 as input 1412 or via the database 1408. The model trainer 1312 implements a suitable ML algorithm 1414 to train an ML model 230 on a set of training dataset 1416 from the pre-processed data 1410. The training process involves feeding the pre-processed data 1410 into the ML algorithm 1414 to produce or optimize an ML model 1320. The training process adjusts its parameters until it achieves an initial level of satisfactory performance.

The model trainer 1312 is communicatively coupled to a model evaluator 1314. After an ML model 1320 is trained, the ML model 1320 needs to be evaluated to assess its performance. This is done using various metrics such as accuracy, precision, recall, and F1 score. The model trainer 1312 outputs the ML model 1320, which is received as input 1412 or from the database 1408. The model evaluator 1314 receives the ML model 230 as input 1418, and it initiates an evaluation process to measure performance of the ML model 1320. The evaluation process includes providing feedback 1426 to the model trainer 1312. The model trainer 1312 re-trains the ML model 1320 to improve performance in an iterative manner.

The model evaluator 1314 is communicatively coupled to a model inferencer 1316. The model inferencer 1316 provides AI/ML model inference output (e.g., inferences, predictions or decisions). Once the ML model 1320 is trained and evaluated, it is deployed in a production environment where it is used to make predictions on new data. The model inferencer 1316 receives the evaluated ML model 1320 as input 1422. The model inferencer 1316 uses the evaluated ML model 1320 to produce insights or predictions on real data, which is deployed as a final production ML model 1320. The inference output of the ML model 1320 is use case specific. The model inferencer 1316 also performs model monitoring and maintenance, which involves continuously monitoring performance of the ML model 1320 in the production environment and making any necessary updates or modifications to maintain its accuracy and effectiveness. The model inferencer 1316 provides feedback 1426 to the data collector 1310 to train or re-train the ML model 1320. The feedback 1426 includes model performance feedback information, which is used for monitoring and improving performance of the ML model 1320.

Some or all of the model inferencer 1316 is implemented by various actors 1424 in the logic diagram 1400, including the ML model 1320 of the connection network platform 112, for example. The actors 1424 use the deployed ML model 1320 on new data to make inferences or predictions for a given task, and output a prediction 1432. The actors 1424 implement the model inferencer 1316 locally, or remotely receives outputs from the model inferencer 1316 in a distributed computing manner. The actors 1424 trigger actions directed to other entities or to itself. The actors 1424 provide feedback 1428 to the data collector 1310 via the model inferencer 1316. The feedback 1428 comprise data needed to derive training data, inference data or to monitor the performance of the ML model 1320 and its impact to the network through updating of key performance indicators (KPIs) and performance counters.

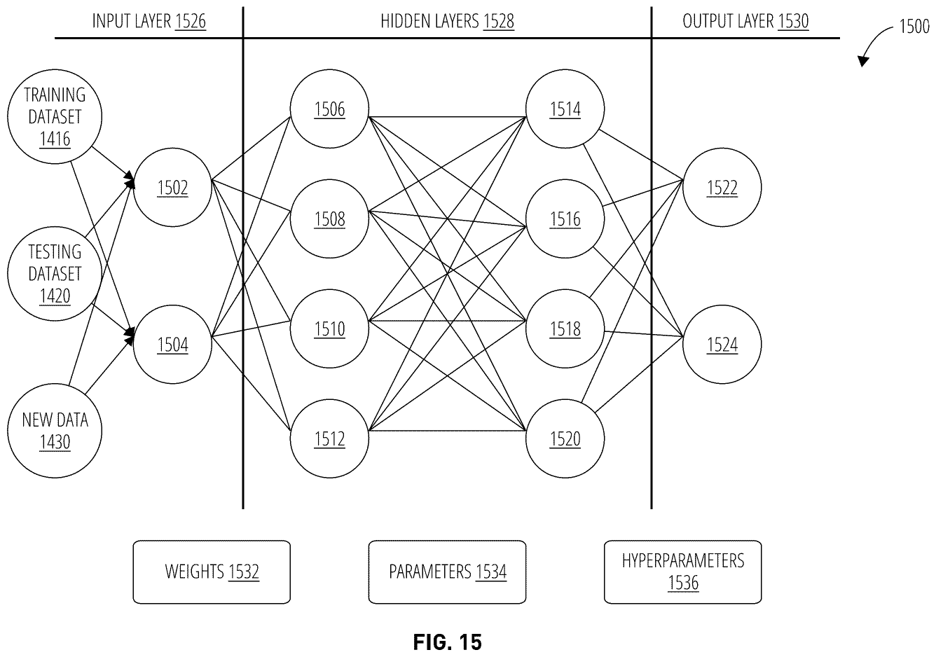

As previously described with reference to FIGS. 1, 2, the connection network system 100 and/or the apparatus 1300 may implement some or all of the logic diagram 1400 to support various use cases and solutions for various AI/ML tasks. In various embodiments, the training device 1302 of the apparatus 1300 uses the logic diagram 1400 to generate and train the ML model 230 for use by the connection network platform 112 for the client application 110. In one embodiment, for example, the training device 1302 may train the ML model 1320 as a neural network, as described in more detail with reference to FIG. 15. Other use cases and solutions for AI/ML are possible as well, and embodiments are not limited in this context.

FIG. 15 illustrates an embodiment of an artificial neural network 1500. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1500 comprises multiple node layers, containing an input layer 1526, one or more hidden layers 1528, and an output layer 1530. Each layer comprises one or more nodes, such as nodes 1502 to 1524. As depicted in FIG. 15, for example, the input layer 1526 has nodes 1502, 1504. The artificial neural network 1500 has two hidden layers 1528, with a first hidden layer having nodes 1506, 1508, 1510 and 1512, and a second hidden layer having nodes 1514, 1516, 1518 and 1520. The artificial neural network 1500 has an output layer 1530 with nodes 1522, 1524. Each node 1502 to 1524 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1500 relies on training dataset 1416 to learn and improve accuracy over time. However, once the artificial neural network 1500 is fine-tuned for accuracy, and tested on testing dataset 1420, the artificial neural network 1500 is ready to classify and cluster new data 1430 at a high velocity. Tasks in speech recognition or image recognition can take minutes versus hours when compared to the manual identification by human experts.

Once an input layer 1526 is determined, a set of weights 1532 are assigned. The weights 1532 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1500 as a feedforward network.

In one embodiment, the artificial neural network 1500 leverages sigmoid neurons, which are distinguished by having values between 0 and 1. Since the artificial neural network 1500 behaves similarly to a decision tree, cascading data from one node to another, having x values between 0 and 1 will reduce the impact of any given change of a single variable on the output of any given node, and subsequently, the output of the artificial neural network 1500.

The artificial neural network 1500 has many practical use cases, like image recognition, speech recognition, text recognition or classification. The artificial neural network 1500 leverages supervised learning, or labeled datasets, to train the algorithm. As the model is trained, its accuracy is measured using a cost (or loss) function. This is also commonly referred to as the mean squared error (MSE). An example of a cost function is shown in Equation (4), as follows:

$$Cost Function = MSE = \frac{1}{2 m} {\sum }_{i = 1}^{m} {( \hat{{y}_{i}} - {y}_{i} )}^{2} \to MIN \qquad EQUATION ( 4 )$$

In Equation (3), i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1534 of the model adjust to gradually converge at the minimum.

In one embodiment, the artificial neural network 1500 is feedforward, meaning it flows in one direction only, from input to output. In one embodiment, the artificial neural network 1500 uses backpropagation. Backpropagation is when the artificial neural network 1500 moves in the opposite direction from output to input. Backpropagation allows calculation and attribution of errors associated with each neuron 1502 to 1524, thereby allowing adjustment to fit the parameters 1534 of the ML model 230 appropriately.

The artificial neural network 1500 is implemented as different neural networks depending on a given task. Neural networks are classified into different types, which are used for different purposes. In one embodiment, the artificial neural network 1500 is implemented as a feedforward neural network, or multi-layer perceptrons (MLPs), comprised of an input layer 1526, hidden layers 1528, and an output layer 1530. While these neural networks are also commonly referred to as MLPs, they are actually comprised of sigmoid neurons, not perceptrons, as most real-world problems are nonlinear. Trained data 1404 usually is fed into these models to train them, and they are the foundation for computer vision, natural language processing, and other neural networks. In one embodiment, the artificial neural network 1500 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1500 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1500 is implemented as any type of neural network suitable for a given operational task of system 200, and the MLP, CNN, and RNN are merely a few examples. Embodiments are not limited in this context.

The artificial neural network 1500 includes a set of associated parameters 1534. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1500 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1536. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

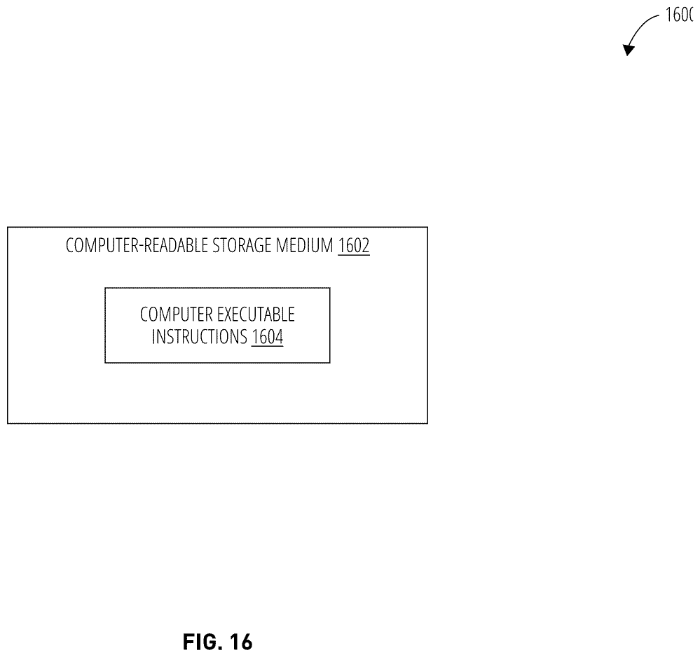

FIG. 16 illustrates an apparatus 1600. Apparatus 1600 comprises any non-transitory computer-readable storage medium 1602 or machine-readable storage medium, such as an optical, magnetic or semiconductor storage medium. In various embodiments, apparatus 1600 comprises an article of manufacture or a product. In some embodiments, the computer-readable storage medium 1602 stores computer executable instructions with which one or more processing devices or processing circuitry can execute. For example, computer executable instructions 1604 includes instructions to implement operations described with respect to any logic flows described herein. Examples of computer-readable storage medium 1602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1604 include any suitable type of code, such as source code, compiled code, interpreted code, executable code, static code, dynamic code, object-oriented code, visual code, and the like.

FIG. 17 illustrates an embodiment of a computing architecture 1700. Computing architecture 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1700 has a single processor with one core or more than one processor. Note that the term “processor” refers to a processor with a single core or a processor package with multiple processor cores. In at least one embodiment, the computing architecture 1700 is representative of the components of the system 200. More generally, the computing architecture 1700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 17, computing architecture 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the computing architecture 1700 is another bus architecture, such as a multi-drop bus. Furthermore, each of processor 1704 and processor 1706 are processor packages with multiple processor cores including core(s) 1708 and core(s) 1710, respectively. While the computing architecture 1700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1704 and chipset 1732. Some platforms include additional components and some platforms include sockets to mount the processors and/or the chipset. Furthermore, some platforms do not have sockets (e.g. SoC, or the like). Although depicted as a SoC 1702, one or more of the components of the SoC 1702 are included in a single die package, a multi-chip module (MCM), a multi-die package, a chiplet, a bridge, and/or an interposer. Therefore, embodiments are not limited to a SoC.

The processor 1704 and processor 1706 are any commercially available processors, including without limitation an Intel® Celeron®, Core®, Core (2) Duo®, Itanium®, Pentium® Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (i.e., processor 1704 and processor 1706). In other embodiments, the main memory couple with the processors via a bus and shared memory hub. Processor 1704 includes registers 1712 and processor 1706 includes registers 1714.

Computing architecture 1700 includes chipset 1732 coupled to processor 1704 and processor 1706. Furthermore, chipset 1732 are coupled to storage device 1750, for example, via an interface (I/F) 1738. The I/F 1738 may be, for example, a Peripheral Component Interconnect-enhanced (PCIe) interface, a Compute Express Link® (CXL) interface, or a Universal Chiplet Interconnect Express (UCIe) interface. Storage device 1750 stores instructions executable by circuitry of computing architecture 1700 (e.g., processor 1704, processor 1706, GPU 1748, accelerator 1754, vision processing unit 1756, or the like). For example, storage device 1750 can store instructions for the client device 202, the client device 206, the inferencing device 204, the training device 1302, or the like.

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 couple the P2P interface 1728 and the P2P 1734 and the P2P interface 1730 and P2P 1736, respectively. DMI 1776 and DMI 1778 is a high-speed interconnect that facilitates, e.g., eight Giga Transfers per second (GT/s) such as DMI 3.0. In other embodiments, the processor 1704 and processor 1706 interconnect via a bus.

The chipset 1732 comprises a controller hub such as a platform controller hub (PCH). The chipset 1732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 comprises more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code. The I/F 1742 may also be coupled to a network interface circuit (NIC) 1780 for connections off-chip.

Furthermore, chipset 1732 includes the I/F 1738 to couple chipset 1732 with a high-performance graphics engine, such as, graphics processing circuitry or a graphics processing unit (GPU) 1748. In other embodiments, the computing architecture 1700 includes a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The computing architecture 1700 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1754 and/or vision processing unit 1756 are coupled to chipset 1732 via I/F 1738. The accelerator 1754 is representative of any type of accelerator device (e.g., a data streaming accelerator, cryptographic accelerator, cryptographic co-processor, an offload engine, etc.). One example of an accelerator 1754 is the Intel® Data Streaming Accelerator (DSA). The accelerator 1754 is a device including circuitry to accelerate copy operations, data encryption, hash value computation, data comparison operations (including comparison of data in memory 1716 and/or memory 1718), and/or data compression. Examples for the accelerator 1754 include a USB device, PCI device, PCIe device, CXL device, UCIe device, and/or an SPI device. The accelerator 1754 also includes circuitry arranged to execute machine learning (ML) related operations (e.g., training, inference, etc.) for ML models. Generally, the accelerator 1754 is specially designed to perform computationally intensive operations, such as hash value computations, comparison operations, cryptographic operations, and/or compression operations, in a manner that is more efficient than when performed by the processor 1704 or processor 1706. Because the load of the computing architecture 1700 includes hash value computations, comparison operations, cryptographic operations, and/or compression operations, the accelerator 1754 greatly increases performance of the computing architecture 1700 for these operations.

The accelerator 1754 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1754. For example, the accelerator 1754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1754 via a non-posted write (e.g., a deferred memory write (DMWr)). One example of an instruction that atomically submits a work descriptor to the shared work queue of the accelerator 1754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1754. The dedicated work queue may accept job submissions via commands such as the movdir64b instruction.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 is a low pin count (LPC) bus. Various input/output (I/O) devices couple to the second bus 1774 including, for example, a keyboard 1762, a mouse 1764 and communication devices 1766.

Furthermore, an audio I/O 1768 couples to second bus 1774. Many of the I/O devices 1760 and communication devices 1766 reside on the system-on-chip (SoC) 1702 while the keyboard 1762 and the mouse 1764 are add-on peripherals. In other embodiments, some or all the I/O devices 1760 and communication devices 1766 are add-on peripherals and do not reside on the system-on-chip (SoC) 1702.

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, power supplies, and so forth. The embodiments, however, are not limited to implementation by the communications architecture 1800.

As shown in FIG. 18, the communications architecture 1800 includes one or more clients 1802 and servers 1804. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 communicate information between each other using a communication framework 1806. The communication framework 1806 implements any well-known communications techniques and protocols. The communication framework 1806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1802 and the servers 1804. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or an entity equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect entity privacy. Furthermore, the techniques described herein may be implemented with entity privacy safeguards to prevent unauthorized access to personal data and confidential data. The training of the AI models described herein is executed to benefit all entities fairly, without causing or amplifying unfair bias.

According to some embodiments, the techniques for the models described herein do not make inferences or predictions about individuals unless requested to do so through an input. According to some embodiments, the models described herein do not learn from and are not trained on entity data without entity authorization. In instances where entity data is permitted and authorized for use in AI features and tools, it is done in compliance with an entity's visibility settings, privacy choices, entity agreement and descriptions, and the applicable law. According to the techniques described herein, entities may have full control over the visibility of their content and who sees their content, as is controlled via the visibility settings. According to the techniques described herein, entities may have full control over the level of their personal data that is shared and distributed between different AI platforms that provide different functionalities. According to the techniques described herein, entities may choose to share personal data with different platforms to provide services that are more tailored to the entities. In instances where the entities choose not to share personal data with the platforms, the choices made by the entities will not have any impact on their ability to use the services that they had access to prior to making their choice.

According to the techniques described herein, entities may have full control over the level of access to their personal data that is shared with other parties. According to the techniques described herein, personal data provided by entities may be processed to determine prompts when using a generative AI feature at the request of the entity, but not to train generative AI models. In some embodiments, entities may provide feedback while using the techniques described herein, which may be used to improve or modify the platform and products. In some embodiments, any personal data associated with an entity, such as personal information provided by the entity to the platform, may be deleted from storage upon entity request. In some embodiments, personal information associated with an entity may be permanently deleted from storage when an entity deletes their account from the platform.

According to the techniques described herein, personal data may be removed from any training dataset that is used to train AI models. The techniques described herein may utilize tools for anonymizing member and customer data. For example, entity's personal data may be redacted and minimized in training datasets for training AI models through delexicalisation tools and other privacy enhancing tools for safeguarding entity data. The techniques described herein may minimize use of any personal data in training AI models, including removing and replacing personal data. According to the techniques described herein, notices may be communicated to entities to inform how their data is being used and entities are provided controls to opt-out from their data being used for training AI models.

According to some embodiments, tools are used with the techniques described herein to identify and mitigate risks associated with AI in all products and AI systems. In some embodiments, notices may be provided to entities when AI tools are being used to provide features.

What is claimed is:

1. A method, comprising:
receiving a request for a set of content items for a content feed of a connection network system, the set of content items comprising different types of content items;
generating, by an online execution system, a set of metrics for a first set of content items of a first type and a second set of candidate content items of a second type using a machine learning (ML) model, wherein the ML model is a deep Q network (DQN) model trained using a reinforcement learning algorithm by an offline execution system of the connection network system;
selecting, by the online execution system, a first content item of the first type from the first set of content items and a second content item of the second type from the second set of content items based on the set of metrics using a blending algorithm to form a blended set of content items;
allocating, by the online execution system, the first content item and the second content item from the blended set of content items to multiple slots in the content feed; and
causing the blended set of content items within the content feed to be presented on a graphical user interface (GUI) of a device.

2. The method of claim 1, wherein the first type is an organic content item and the second type is a sponsored content item.

3. The method of claim 1, wherein the set of metrics comprise longer term Q values generated by the DQN model using a longer observation window greater than a defined temporal length.

4. The method of claim 1, comprising:
receiving an input vector comprising state features and action features;
generating an output vector comprising the set of metrics using a deep Q network (DQN) model, the set of metrics comprising Q values; and
outputting the set of metrics to the blending algorithm of a feed mixer.

5. The method of claim 1, comprising training the DQN model using the reinforcement learning algorithm by the offline execution system.

6. The method of claim 1, wherein the ML model is a cross deep Q network (DQN) model comprising an item representation module (IRM) and a sequential decision module (SDM).

7. The method of claim 6, comprising:
receiving a set of features by an input layer of the IRM, the set of features comprising context features, entity profile features, an entity activity sequence, a sponsored update sequence, and an organic update sequence;
generating a state embedding from the set of features; and
outputting the state embedding to the SDM.

8. The method of claim 6, comprising:
receiving a state embedding as an input to a V network of the SDM;
receiving a set of candidate actions as an input to an A network of the SDM;
generating a set of Q values corresponding to the set of candidate actions; and
outputting the set of Q values to the blending algorithm of a feed mixer.

9. The method of claim 6, comprising:
training the IRM and SDM of the cross DQN model using the reinforcement learning algorithm by the offline execution system; and
deploying the IRM and SDM of the cross DQN model as separate sub-models in the online execution system to generate the metrics.

10. The method of claim 1, comprising:
training the ML model using the reinforcement learning algorithm by the offline execution system;
deploying the trained ML model to the online execution system for inferencing operations;
receiving feedback information from the GUI of the client application associated with an arrangement of content items within the content feed by the online execution system;
retraining the ML model using the reinforcement learning algorithm and the feedback information by the offline execution system; and
deploying the retrained ML model to the online execution system for inferencing operations.

11. A computing apparatus comprising:
circuitry; and
a memory storing instructions that, when executed by the circuitry, causes the circuitry to:
receive a request for a set of content items for a content feed of a connection network system, the set of content items comprising different types of content items;
generate, by an online execution system, a set of metrics for a first set of content items of a first type and a second set of candidate content items of a second type using a machine learning (ML) model, wherein the ML model is a deep Q network (DQN) model trained using a reinforcement learning algorithm by an offline execution system of the connection network system;
select, by the online execution system, a first content item of the first type from the first set of content items and a second content item of the second type from the second set of content items based on the set of metrics using a blending algorithm to form a blended set of content items;
allocate, by the online execution system, the first content item and the second content item from the blended set of content items to multiple slots in the content feed; and
cause the blended set of content items within the content feed to be presented on a graphical user interface (GUI) of a device.

12. The computing apparatus of claim 11, wherein the first type is an organic content item and the second type is a sponsored content item.

13. The computing apparatus of claim 11, wherein the set of metrics comprise longer term Q values generated by the DQN model using a longer observation window greater than a defined temporal length.

14. The computing apparatus of claim 11, the circuitry to train the DQN model using the reinforcement learning algorithm by the offline execution system.

15. The computing apparatus of claim 11, wherein the ML model is a cross deep Q network (DQN) model comprising an item representation module (IRM) and a sequential decision module (SDM).

16. A non-transitory computer-readable storage medium, the computer-readable storage medium including instructions that when executed by circuitry, cause the circuitry to:
receive a request for a set of content items for a content feed of a connection network system, the set of content items comprising different types of content items;
generate, by an online execution system, a set of metrics for a first set of content items of a first type and a second set of candidate content items of a second type using a machine learning (ML) model, wherein the ML model is a deep Q network (DQN) model trained using a reinforcement learning algorithm by an offline execution system of the connection network system;
select, by the online execution system, a first content item of the first type from the first set of content items and a second content item of the second type from the second set of content items based on the set of metrics using a blending algorithm to form a blended set of content items;
allocate, by the online execution system, the first content item and the second content item from the blended set of content items to multiple slots in the content feed; and
cause the blended set of content items within the content feed to be presented on a graphical user interface (GUI) of a device.

17. The computer-readable storage medium of claim 16, wherein the first type is an organic content item and the second type is a sponsored content item.

18. The computer-readable storage medium of claim 16, wherein the set of metrics comprise longer term Q values generated by the DQN model using a longer observation window greater than a defined temporal length.

19. The computer-readable storage medium of claim 16, comprising instructions that when executed by circuitry, cause the circuitry to train the DQN model using the reinforcement learning algorithm by the offline execution system.

20. The computer-readable storage medium of claim 16, wherein the ML model is a cross deep Q network (DQN) model comprising an item representation module (IRM) and a sequential decision module (SDM).
